(19) United States
(12) Patent Application Publication
(10) Pub. No.: US 2007/0087771 A1
(43) Pub. Date: Apr. 19, 2007

(54) Test Access Point Having Wireless Communication Capabilities

(76) Inventors: Gayle Loretta Noble, Boulder Creek, CA (US); Derek Anthony Jones, Orem, UT (US); Jonathan Michael Hudson, Sunnyvale, CA (US); William David Teeple, San Jose, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/537,595

(22) Filed: Sep. 29, 2006

Related U.S. Application Data
(63) Continuation-in-part of application No. 11/134,786, filed on May 20, 2005.

(51) Int. Cl. H04B 7/00

(52) U.S. Cl. 455/522

(57) ABSTRACT

This disclosure relates to a network test access point (“TAP”) with wireless communication capabilities. In one example embodiment, a network TAP includes an input port configured for communication with a data line and an output port configured for communication with a data line. The output port is at least indirectly connected with the input port. The network TAP also includes a power assembly and a wireless transmitter connected with the power assembly. The wireless transmitter is configured to receive data by way of the input port and to transmit the received data over a wireless channel.

### CROSS-REFERENCE TO RELATED APPLICATIONS

This application is a continuation-in-part of, and claims priority to, United States utility patent application Ser. No. 11/134,786 filed on May 20, 2005, which is incorporated herein by reference in its entirety.

### BACKGROUND OF THE INVENTION

1. The Field of the Invention

The present invention relates to wireless diagnostic systems. More particularly, the present invention relates to a test access point with wireless communication capabilities.

2. The Related Technology

Diagnostic devices are useful in acquiring information pertaining to the operation of various components on a network. A Storage Area Network probe (“SAN probe”) is one type of diagnostic device that is configured to monitor and/or analyze components in a SAN. A typical SAN probe is physically connected into a SAN by using various cable and transceiver modules to establish communication between the probe and the network. While SAN probes have been valuable for providing accurate real-time statistics, the installation of probes is cost-prohibitive.

Additionally, Local Area Network probes (“LAN probes”) are diagnostic devices that can be used to monitor and/or analyze a LAN. LAN probes have served useful in monitoring, measuring, analyzing and troubleshooting an enterprise LAN. However, similar to the SAN probes, LAN probes must also be physically connected into the LAN before any analysis or monitoring can be performed.

In both SANs and LANs as well as other networks, the sheer number of network devices can require a large number of diagnostic devices to be placed at strategic links. In some systems, having to physically connect a diagnostic device at each of these strategic links has limited the feasibility of their application. For example, an enterprise may have to be satisfied with fewer diagnostic devices if the cost of applying a diagnostic device in every desired location is too cost-prohibitive.

Conventionally, a network diagnostic device has had to be physically connected to a device in order to monitor and/or analyze the device. The diagnostic device is typically spliced into a physical transmission line between one or more end point devices using, for example, a network test access point (“TAP”) device, which enables the diagnostic device to monitor data passing between the end point devices, such as traffic data or other diagnostic data, for example. In other words, a one-to-one ratio is typically required between diagnostic devices and end point devices being monitored. Thus, a person designing a diagnostic system may need to choose fewer diagnostic devices to meet budget constraints because of the prohibitively high cost of a large number of diagnostic devices.

Finally, there is always a demand for fewer hardware and connection pieces in networks, to reduce the complexity and time to configure a network. Further, there is a constant demand to make individual network components smaller and more portable. However, diagnostic devices have generally been configured as pieces of hardware that are physically wired into a system in order to gain access to the data transmitted within the system. In addition, diagnostic devices have been difficult to locate in close physical proximity to the network devices themselves, such as storage devices, servers, clients, printers, and the like, due to the bulkiness of the diagnostic devices.

### BRIEF SUMMARY OF SOME EXAMPLE EMBODIMENTS

The foregoing problems are overcome by the principles of the present invention, which relate to a test access point with wireless communication capabilities. In one embodiment, wireless communication is provided between a wireless transceiver located on an end point device and a wireless transceiver of a wireless diagnostic device. Additionally, wireless diagnostic systems of the present invention can include other wireless devices having wireless transceivers.

In one example embodiment, a network TAP includes an input port configured for communication with a data line, and an output port configured for communication with a data line. The output port is at least indirectly connected with the input port. The network TAP also includes a power assembly and a wireless transmitter connected with the power assembly. The wireless transmitter is configured to receive data by way of the input port and to transmit data over a wireless channel.

In another example embodiment, an optical network TAP includes an optical input port configured for communication with an optical data line, and an optical output port configured for communication with an optical data line. The optical output port is at least indirectly connected with the optical input port. The network TAP also includes a power assembly and a wireless transmitter connected with the power assembly. The wireless transmitter is configured to receive data by way of the optical input port and to transmit data over a wireless channel.

In yet another example embodiment, an electrical network TAP includes an electrical input port configured for communication with an electrical data line and an electrical output port configured for communication with an electrical data line. The electrical output port is at least indirectly connected with the electrical input port. The network TAP also includes a power assembly and a wireless transmitter connected with the power assembly. The wireless transmitter is configured to receive data by way of the electrical input port and to transmit data over a wireless channel.

These and other aspects of embodiments of the present invention will become more fully apparent from the following description and appended claims.

### BRIEF DESCRIPTION OF THE DRAWINGS

To further clarify aspects of the present invention, a more particular description of the invention will be rendered by reference to specific embodiments thereof which are disclosed in the appended drawings. It is appreciated that these drawings depict only typical embodiments of the invention and are therefore not to be considered limiting of its scope. The invention will be disclosed and explained with additional specificity and detail through the use of the accompanying drawings in which:

FIG. 1 is a schematic diagram that illustrates one exemplary wireless diagnostic system;

FIGS. 2A through 2B are schematic diagrams that illustrate other embodiments of a wireless diagnostic system;

FIGS. 3 through 5 illustrate yet other embodiments of a wireless diagnostic system;

FIGS. 6A through 6E are schematic diagrams of embodiments of wireless transceiver modules and wireless transceiver adapters;

FIG. 7 is a schematic diagram of yet another embodiment of a wireless diagnostic system;

FIG. 8A illustrates another embodiment of a wireless transceiver adapter;

FIG. 8B illustrates an embodiment of a portable storage device having a wireless transceiver;

FIG. 9 through 11A are schematic diagrams illustrating still other embodiments of a wireless diagnostic systems;

FIG. 11B is an exemplary user interface for configuring diagnostic analysis parameters;

FIG. 12 is a schematic diagram that illustrates an exemplary embodiment of a wireless diagnostic device; and

FIG. 13 illustrates an exemplary method using a shared resource configuration.

### DETAILED DESCRIPTION OF EXAMPLE EMBODIMENTS

Generally, exemplary embodiments of the present invention relate to diagnostic systems configured to, among other things, test and/or evaluate components within the diagnostic system. Typically, the diagnostic systems of the present invention are implemented in connection with high-speed data transmission systems. However, embodiments of the invention may be used in other contexts unrelated to testing system components and/or unrelated to high speed data transmission. Exemplary embodiments of the present invention also relate to the disclosures of U.S. utility patent application Ser. No. ______, titled “DIAGNOSTIC DEVICE HAVING WIRELESS COMMUNICATION CAPABILITIES,” attorney docket no. 15436.788.1, U.S. utility patent application Ser. No. ______, titled “WIRELESS DIAGNOSTIC SYSTEMS MANAGEMENT,” attorney docket no. 15436.788.2, U.S. utility patent application Ser. No. ______, titled “RESOURCE ALLOCATION MANAGER FOR WIRELESS DIAGNOSTIC SYSTEMS,” attorney docket no. 15436.788.3, each of which was filed the same day as the present application and is expressly incorporated herein by reference in its entirety.

I. Definitions

Various terms are used consistently throughout the specification and claims, the definition of which are provided for as follows:

The term “wireless” is used to refer to any data transmission that does not occur through a physical transmission medium. Wireless data transmission techniques can thus include, but are not limited to electromagnetic techniques such as using radio frequency (RF), optical techniques such as infrared (IR), acoustic techniques, and the like. Thus, any process or means for transmitting data wirelessly now known or later developed has been contemplated to be applicable to the present invention. The term “physical transmission medium” refers to a physical device such as, but not limited to, an electrical medium (e.g., a metal wire or metal cable), an optical medium (e.g., a fiber optic cable), and the like.

The term “diagnostic system” refers to a system in which it is desired to monitor the operation of one or more end point devices. A diagnostic system contains at least two devices transmitting and/or receiving data from one another. A diagnostic system may be any size of system including, but not limited to, as few as two devices to as many devices necessary to create a LAN, WAN, SAN, Internet, intranet, and the like.

The term “end point device” is used to refer to a device in a diagnostic system whose operation is monitored and which transmits data relating to the operation thereof. Further description of some end points is given below which includes computer systems, storage devices, LAN ports, SAN ports, RAID controllers, and network test access points (“TAPs”). However, the aspects of the present invention can be applied to any end point device which is desired to be monitored for operations including, but not limited to, fax machines, cell phones, printers, and the like.

The term “data” is used to refer to any information relating to the operation of an end point device that is configured into any format which enables the data to be transmitted. Thus, the definition connotes both a format element and a content element. With regard to the format element, the term “data” encompasses any transmission format including, but not limited to, electrical and optical transmissions as well as any other format in which data can be transmitted. The term “data” can include both digital and analog transmission formats. Because “data” can include any transmission format, the present invention extends to any communication protocol, interface equipment, and/or other hardware or software for enabling data transmission in any transmission format such as, but not limited to, serial protocol, fiber channel, small computer systems interface (SCSI), advanced technology attachment (ATA), serial advanced technology attachment (SATA), universal serial bus (USB), fire wire, and the like. Thus, any current or future developed communication protocols are contemplated to be within the scope of the present invention. The term “wirelessly transmitted data” specifically refers to data that is formatted for wireless transmissions (e.g., electromagnetic, optical, acoustic, and the like). The term “signal” is used to refer to any indicator of data that a wireless transmission may use. When information is transmitted wirelessly, it may be sent having certain signal strength depending on the employed wireless data transmission technique.

The data format can also include packaging the data in any manner suitable to a particular protocol being used to transmit the data. That is, data can be transmitted as a data packet; a datagram; a frame; a data frame; a command frame; an ordered set; or any unit of data capable of being routed or otherwise transmitted through a system. Thus, “data” can also comprise transmission characters used for transmission purposes, protocol management purposes, code violation errors, and the like. For example, data may include transmission codes such as, but not limited to, a Start of Frame (“SOF”), an End of Frame (“EOF”), an Idle, a Receiver_Ready (“R_RDY”), a Loop Initialization Primitive (“LIP”), an Arbitrate (“ARB”), an Open (“OPN”), and Close (“CLS”)—such as, those used in certain embodiments of Fibre Channel. Data format may also include any header, addressing or formatting information needed to direct the data to a particular location. Of course, any transmission protocol data of any size, type or configuration may be used, including, but not limited to, those from any other suitable protocols.

The data content is similarly unrestrictive. “Data” can refer to any information relating to the operation of an end point device. For example, “data” can include diagnostic data which is used to further analyze an end point device to produce results data relating to the end point device's proper functioning. Diagnostic data can include statistical data. “Data” can be traffic data relating to the data transmissions of a physical transmission medium which is used to monitor the type of data transmission, security of data transmission, rate of data transmissions, and the like, being transmitted through that particular physical transmission medium. Examples of types of diagnostic data are provided with each exemplary embodiment disclosed below.

“Data” may also include in/out (I/O) data that is transferred between a first end point device and a second end point device. Typically, I/O data is involved when using devices such as printers, storage devices, keyboards, and mouses. Some I/O devices can be input-only devices (keyboards and mouses); others can be output-only devices (printers); while still others can provide both input and output of data (hard disks, diskettes, writable CD-ROMs). The term “data” can also include information that is capable of being displayed (read) and modified (written). Read/write data covers any objects such as disks, files, directories, graphics, or other data content that can be selected and/or manipulated. Thus, I/O data that is read to a disk could be considered read/write data.

The term “wireless transceiver” is used to refer to any hardware or software used to translate physically transmitted data into wirelessly transmitted data or vice versa. Because the term “wireless” can encompass any wireless transmission technique, the term “wireless transceiver” is similarly broadly construed as encompassing any hardware/software required to accomplish such translation. The hardware/software may be discretely contained within a housing unit, or may be disposed on multiple different locations on a wireless device that operate together to form the function of a “wireless transceiver.” For example, components of a wireless transceiver may be located in various areas on one or more printed circuit boards and still be able to accomplish the task of converting physically transmitted data to wirelessly transmitted data or vice versa. Further, a “wireless transceiver” may be formed when coupling one unit containing some wireless transceiver components to a host device that contains other wireless transceiver components to cooperate together to operate as a wireless transceiver. In addition, the term “wireless transceiver” covers both the ability to transmit wirelessly transmitted data and/or to receive wirelessly transmitted data. In some embodiments, some wireless devices of the present invention will only be configured to transmit wirelessly transmitted data or configured to receive wirelessly transmitted data, both of which embodiments are contemplated within the scope of the term “wireless transceiver”. Thus, the term “wireless transceiver” is not dependent on the direction of the wireless transmissions being outgoing or incoming, but can include one or both directions.

The term “wireless transceiver module” is used to refer to a modular or portable unit capable of converting physically transmitted data into wirelessly transmitted data that is couplable or pluggable into a port in another device. The term “wireless transceiver adapter” is used to refer to a modular or portable unit capable of converting physically transmitted data into wirelessly transmitted data that is couplable or pluggable into a port in another device. The other device could be, for example, a non-wireless transceiver module. The term “wireless transceiver daughter card” is used to refer to a circuit board that is configured to electrically connect or plug into another circuit board or mother board, the circuit board capable of converting physically transmitted data to wirelessly transmitted data.

In addition, in devices that only receive and transmit wirelessly transmitted data, but are not required to convert the wirelessly transmitted data into physically transmitted data, the term “wireless transceiver” also refers to hardware or software that is capable of both receiving and transmitting wirelessly transmitted data.

The term “probe” is used to refer to a device that monitors one or more end point devices for the existence of wirelessly transmitted data. The probe is then able to receive the wirelessly transmitted data. A probe may or may not perform analysis on the wirelessly transmitted data, but generally transmits the data onto another analyzer either wirelessly or through a physical transmission medium. A probe may also be connected to one or more end point devices via a physical transmission medium and monitor the transmissions. The probe may then wirelessly transmit the transmissions to another wireless device. Also, a probe can be physically connected to one or more end point devices to monitor data therefrom, and then wirelessly broadcast any relevant data to another wireless device.

The term “diagnostic device” refers to a device that can monitor one or more end point devices for the existence of wirelessly transmitted data. The diagnostic device is then able to receive the wirelessly transmitted data and perform at least some analysis on the data to produce results data. The diagnostic device may or may not retransmit the data or results data to another analyzer either wirelessly or through a physical transmission medium.

The term “analyzer” refers to a diagnostic device that receives information from a probe or another diagnostic device. As such, it is able to receive data via physical transmission or wireless transmission. Besides the fact that the analyzer is at least one step removed from the end point devices and that it can obtain information via physical communication as well as wireless communication, in all other respects, the term “analyzer” should be given the same interpretation as a diagnostic device.

The terms “test access point” or “TAP” refer to a device that monitors data transmission on a physical transmission medium. The TAP may then wirelessly transmit the transmissions to another wireless device.

Other terms will be further defined herein in the following and in the claims.

II. Exemplary Operating Environment

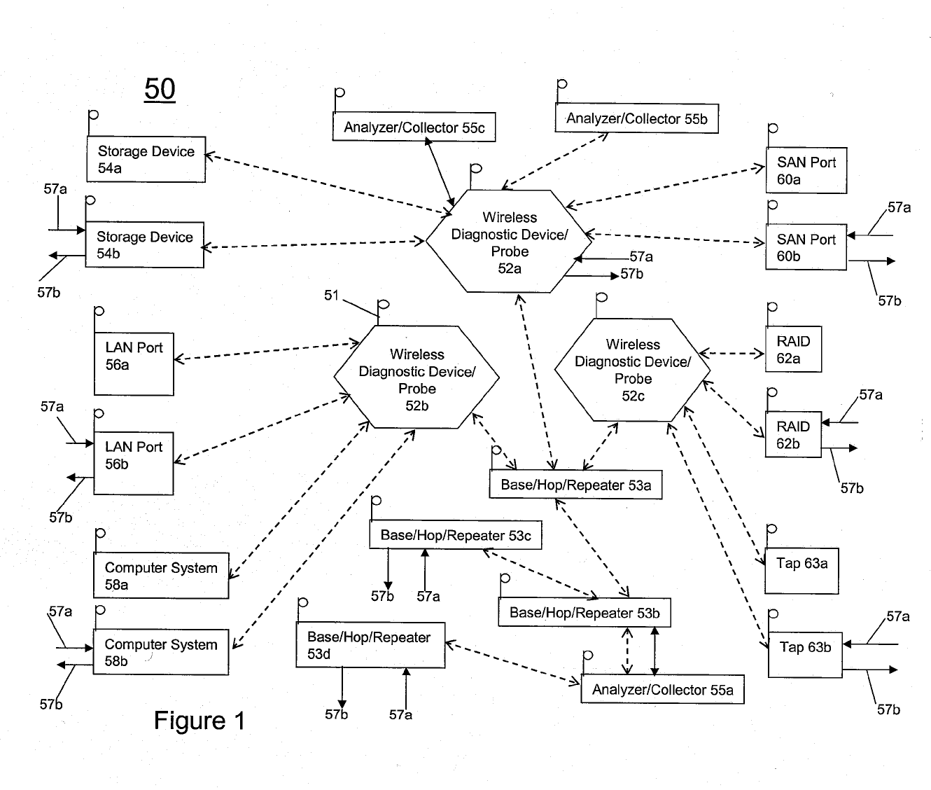

FIG. 1 is a schematic diagram that illustrates aspects of one exemplary operating environment in accordance with the present invention. As shown in FIG. 1, a wireless diagnostic system 50 can be formed from various components. Wireless diagnostic system 50 can be, but is not limited to, a LAN, WAN, SAN, Internet, intranet, and the like. Wireless diagnostic system 50 can include, among other things, a wireless diagnostic device/probe 52 (hereinafter “WDD/probe”), which can be a diagnostic device outfitted with wireless hardware and software. As will be discussed in further detail below, WDD/probe 52 includes wireless communication hardware and software that is configured to enable wireless communication between WDD/probe 52 and other components within wireless diagnostic system 50, the other components also being outfitted with wireless communication capabilities. In addition, WDD/probe 52 can include an antenna 51 so that wireless communication can be transmitted and received with optimal signal integrity. The antenna 51 is repeated in various drawings to symbolize that an end point device or component thereof, WDD/probe, or other device in the system can be configured with hardware or software providing wireless capabilities.

The dashed lines between WDD/probe 52 and the other components of wireless diagnostic system 50 emphasizes that communication is wireless. On the other hand, the solid arrows 57 indicate that the WDD/probe 52a and/or other components can communicate via physical transmission media, wherein arrow 57a indicates incoming data and arrow 57b indicates outgoing data. The dashed/dotted lines shown in some of the figures indicate that transmission can occur either by wireless transmission or physical transmission.

Exemplarily, WDD/probe 52 monitors data transmissions from various end point devices on wireless diagnostic system 50. The end point devices contain sensing hardware and/or software for monitoring activity thereon. The end point devices also include hardware and/or software for transmitting data containing the monitored information to WDD/probe 52. Optionally, the end point devices can include physical transmission devices 57a-b for data communication. WDD/probe 52 can monitor various end point devices simultaneously or may switch between multiple end point devices. WDD/probe 52 receives the transmitted data and can either analyze the data or retransmit the data to (1) a base station/frequency hop/repeater 53a-d, or (2) to an analyzer/collector 55a-c.

Base station/frequency hop/repeater 53a-d (hereinafter “base/hop/repeater”) can optionally be disposed between a WDD/probe 52 or other end point device and analyzer/collector 55a-c. In one embodiment, base/hop/repeater 53 is a base station, which refers to any fixed transmission and reception station for handling wireless traffic. A base station generally includes a transceiver which receives and transmits wirelessly transmitted data to another base/hop/repeater 53 or analyzer/collector 55. A frequency hop is any structure that modulates carrier signals such that the signal from a probe 52 or other end point device can change channels or frequencies. Hopping can occur using a predictable or random method. A repeater is any structure which generally amplifies, retimes, and/or reconstructs a signal. A series of repeaters can make possible transmission of a signal over a long distance. Repeaters can remove unwanted noise in an incoming signal, amplify a signal, and may also include an isolator to prevent strong signals from damaging the receiver. Further, a single device could provide one or more of the functions of a base station, frequency hop or repeater. Finally, aspects of base stations, hops or repeaters could be combined in other system devices such as in the WDD/probe 52a-c or analyzer 55/collector 55a-c

As disclosed herein, base/hop/repeater 53a-d can include components which enable wireless communications with various components in the wireless diagnostic system 50, including WDDs/probes 52a-c. A base/hop/repeater 53a-d may switch between multiple wireless probes 52. Additionally, base/hop/repeaters 53c and d can be wired to physical transmission devices 57a and 57b.

Eventually, data from one or more end point devices is transmitted to an analyzer/collector 55. An analyzer is any hardware and/or software configured to analyze collected data, such as the diagnostic devices disclosed herein. Thus, the analyzer could be, for example, a client computer having analyzing software, or a specialized hardware device designed with analyzing software. After analyzing the data, the analyzer can send the results data to another device on the system. A collector is hardware or software that acts as a repository for collected data, wherein the collected data can then be accessed or otherwise transmitted to another device. The collector could be, for example, a server having data storage and/or reporting software.

The analyzer/collector 55 may also generate or receive control signals based on the analysis of the collected data, and may transmit the control signal back via the same or a different pathway back to the originating end point device. For example, the analyzer/collector 55 may send a control signal back to a base/hop/repeater 53, which redirects the control signal to the appropriate wireless probe 52, which then sends the control signal to the correct end point device. As such, each component in wireless diagnostic system 50 can potentially send and/or receive wirelessly transmitted data, which can include diagnostic data or any other type of data.

In at least one embodiment, wireless communication is accomplished using radio frequency (RF) signals generated and/or received using wireless transceivers. The wireless transceivers are circuitry and/or hardware that convert data to RF signals, data to RF signals, and vice versa. The RF transceivers, for example, contain a microchip enabled with RF circuitry. In one embodiment, the microchip is able to transmit and receive over distances of up to 5 miles. In other embodiments, the microchip can transmit and receive over distances of more than 5 miles. Alternatively, the microchip can transmit and receive at a relatively lower frequency to transmit an RF signal to WDD/probe 52 or base/hop/repeater 53, which can then retransmit the signal at a higher frequency. However, other wireless transmission techniques can be used and are within the scope of the present invention.

Generally, wireless devices of the present invention can be employed to reduce or minimize, where possible, the number of physical connections to a network so as to decrease the cost of implementing a diagnostic system. However, a “wireless” component may also have some elements of physical connections (e.g., metal wire or fiber optic cable) in order to allow the component to perform its sensing, collecting, monitoring and/or analyzing functions, yet still be able to communicate the sensed, collected, monitored and/or analyzed data wirelessly to a probe and/or other components.

Some exemplary end point devices of the networks of the present invention will now be disclosed in further detail. As shown in FIG. 1, at least one embodiment of wireless diagnostic system 50 may include data storage devices 54a-b. Each storage device 54a-b can include hardware and software that is configured to enable wireless communication with WDD/probe 52, with the other storage devices 54a-b, and/or other components in the network outfitted with wireless communication capabilities. For example, storage device 54a can have hardware and software for transmitting and receiving diagnostic data and/or read/write data. In addition, storage device 54b is disclosed as having physical transmission media 57a, 57b for physical data communications. An example of a storage device can be a hard storage device, data platter, storage device stack, or any medium suitable for storing information, such as those media incorporating optical technology, and the like. Also, storage devices 54a-b can be configured to operate with either static or dynamic IP in order to wirelessly communicate with WDD/probe 52.

Wireless diagnostic system 50 may include one or more LAN ports 56a-b. Such LAN ports 56a-b can be considered to be any electronic devices configured to TAP into a LAN. LAN ports 56a-b are also outfitted with wireless communication capabilities to enable wireless communication with WDD/probe 52, as well as other wireless components in wireless diagnostic system 50. More particularly, LAN port 56a can communicate with hardware and software for transmitting and receiving data, such as statistical data. In addition, LAN port 56b is disclosed having physical transmission devices 57a-b to receive and transmit data communications. As such, LAN ports 56a-b can enable WDD/probe 52 to access data therefrom in order to monitor and/or analyze any of the various functionalities or protocols operating thereon. Moreover, it will be recognized that any of LAN ports 56a-b could also be WAN ports, Internet ports, intranet ports, and like data communication ports, wherein such LAN ports can be configured to communicate with WDD/probe 52 by having a static or dynamic IP address.

Wireless diagnostic system 50 may include one or more computer systems 58a-b. Computer systems 58a-b can be configured to access the wireless diagnostic system 50 via WDD/probe 52 as well as other networks, such as the Internet, through standard network connections (including wireless). Also, computer systems 58a-b include hardware and software that are configured to enable wireless communication between other computer systems 58a-b as well as any wireless enabled component within wireless diagnostic system 50, which can be used for transmitting and receiving diagnostic data, I/O data, and/or read/write data. In addition, computer system 58b is disclosed having physical transmission devices 57a-b to receive and transmit data communications. In order to communicate with WDD/probe 52, each computer system 58a-b can include a dynamic or static IP address. Exemplary computer systems 58a-b include personal computers, laptop computers, PDAs, and the like.

In at least one embodiment, wireless diagnostic system 50 includes one or more SAN ports 60a-b. SAN ports 60a-b can be considered to be any electronic device configured to access a SAN, such as by way of a TAP for example, and are outfitted with wireless communication capabilities to communicate with WDD/probe 52, as well as with the other components in wireless diagnostic system 50. More particularly, SAN port 60a can have hardware and software for transmitting and receiving data, such as statistical data. In addition, SAN port 60b is disclosed as having physical transmission devices 57a-b for transmitting and receiving data communications. As such, SAN ports 60a-b can enable WDD/probe 52 to access data therefrom in order to monitor and/or analyze any of the various functionalities or protocols operating thereon. Also, to enable proper communication with WDD/probe 52, each SAN port 60a-b can operate with a dynamic or static IP address.

In at least one embodiment, wireless diagnostic system 50 includes one or more Redundant Array of Independent Disks (“RAID”) controllers 62a-b. In order to communicate with WDD/probe 52 as well as other wireless components, RAID controllers 62a-b are equipped with integrated wireless capabilities, or may interface with an adapter that has wireless communication hardware and/or software. More particularly, RAID controller 62a can have hardware and software for transmitting and receiving diagnostic data and/or read/write data with the individual devices in the redundant array as well as with the network diagnostic WDD/probe 52 or other components in the wireless diagnostic system 50. In addition, RAID controller 62b is disclosed as having physical transmission devices 57a-b for data communications with other components in the wireless diagnostic system 50 as well as with the individual devices in the redundant array. In any implementation, the RAID controllers 62a-b can be any controller that controls any type of redundant array of independent storage devices. The RAID controllers 62a-b are I/O devices that control the layout and format of the data, which can place read and/or write data across multiple media or device types according to the RAID group specified. As such, the RAID controller can operate within the redundant array, but also communicate with WDD/probe 52 via wireless communications. Moreover, in order to properly communicate with wireless probe 52, each RAID controller 62a-b can operate with a dynamic or static IP address.

Wireless diagnostic system 50 may also include one or more network TAPs 63a-b. Network TAPs 63a-b are usually placed in-line with a physical transmission medium, generally in such a manner that they do not have an IP address. However, it is possible for a network TAP 63a-b to operate with a static or dynamic IP address. Usually, a communication line is spliced and a network TAP 63a-63b placed therebetween. Thus, the physical transmission lines 57a-b of network TAP 63b represent the spliced ends of a communication line. However, in the network TAPs 63a-b is hardware and/or software to allow the network TAP to communicate wirelessly with WDD/probe 52 as well as other network components for transmitting and receiving diagnostic data and/or read/write data.

In order for the network components disclosed above (as well as other wireless network components that may be used depending on design considerations) to communicate, generally, either workgroup or domain IP communication protocols can be used. In the workgroup communication regime, any of the wireless communication devices can use a static IP address and broadcast the data. In this manner of wireless communication, the wireless device broadcasts a general signal that can be received by all of the other wireless devices in the network. However, the broadcast includes a unique identifier that identifies the intended recipient of the communication. As such, any wireless communication device that receives the communication can compare the broadcasted unique identifier with their own unique identifier so as to determine whether or not there is a match. When the broadcasted unique identifier matches the recipient unique identifier, the recipient will acquire the signal and receive the data being transmitted. On the other hand, when the broadcasted unique identifier does not match the recipient unique identifier, the recipient will ignore the transmission. Thus, workgroup communication protocols can be used so that general transmissions can be filtered by the receiving wireless communication devices based on broadcasted intended recipient unique identifiers.

Under the domain IP communication protocol, the wireless communication device includes a dynamic IP address. That is, the data transmission is configured to determine the IP of the intended recipient so that only the intended recipient receives the data. As such, instead of a filtering mechanism being on the receiving end of the transmission, the transmitter identifies the location of the target recipient by the IP address and only transmits the data to that IP address.

Additionally, the data transmission from any of the wireless components can include a serial number to identify the transmitting entity. The use of a serial number for the individual transmitting device can be used for identification because each of the various components will have a unique serial number. As such, in the example of multiple hard storage devices or storage devices 54a-b, use of the unique serial numbers can enable WDD/probe 52 to distinguish between each of the hard storage devices. Also, it should be recognized that identifying indicia other than the serial number can be used for identification purposes within the wireless diagnostic system 50.

In another example, WDD/probe 52 may also have a unique serial number for determining a general geographic region from which a signal is being transmitted. Where there are multiple network diagnostic WDD/probes 52, this can be important in determining the location in the network experiencing the activity being reported on by a particular network diagnostic WDD/probe 52. Accordingly, the serial number can be used as identification of the transmitting device so that the transmitting device can be tracked down and further analyzed when the WDD/probe 52 finds a problem.

FIG. 1 illustrates that, as contemplated by the invention, wireless communication can occur in a tiered structure. A tiered structure may be useful for example in larger geographic areas where it is desired to maintain the integrity of the signal strength. Base/hop/repeaters 53 can thus act as transmission nodes to bounce a signal from one base/hop/repeater 53 to the next until the signal reaches the analyzer/collector 55 and/or WDD/probe 52. The tiered structure allows fewer components as the tiers progress. In other words, there does not have to be a one-to-one correspondence of transmitting and receiving components.

For example, at the bottom level of the tier, multiple end point devices, e.g., 54a, 54b, 60a and 60b may transmit to a single WDD/probe 52a via low powered transmissions, wherein the single WDD/probe 52a can be considered to be an aggregator. The single WDD/probe 52a can aggregate the low power transmissions and retransmit them at a higher-strength signal. Multiple WDD/probes 52a, 52b, 52c can then transmit to a single base/hop/repeater 53a via high powered transmissions. Thus, base/hop/repeater 53a can also be considered an aggregator. Multiple base/hop/repeaters 53a, 53c can transmit to a succeeding base/hop/repeater 53b and so on, allowing each transmission node to be a converging point for multiple signals. Thus, it is possible for the final analyzers/collector 55 to receive and transmit to multiple WDD/probes 52.

Various configurations for wireless diagnostic system 50 can exist due to the ability to send low-strength and high strength signals. The components of the network can be modularly configured to transmit at higher or lower signals. For example, some or all of the devices of the network may be constructed with chassis having ports or receptacles configured to receive wireless transceivers modules, wireless transceiver daughter cards, wireless transceiver adapters, or other pluggable wireless transceiver devices. The wireless transceiver can be selected based on the desired transmission range of the device. So, for example, where it is desired that end point devices transmit at lower strength, the wireless transceiver is selected for that particular range. Similarly, the wireless transceiver can be selectively placed in hardware devices throughout the network to enable the user to custom-design the transmission range of each device, if so desired.

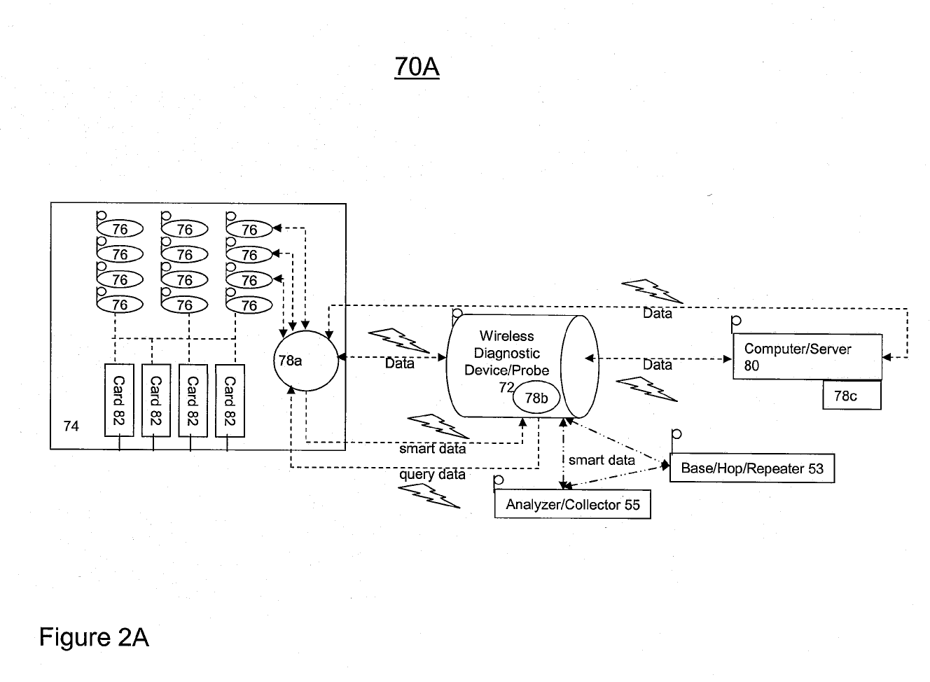

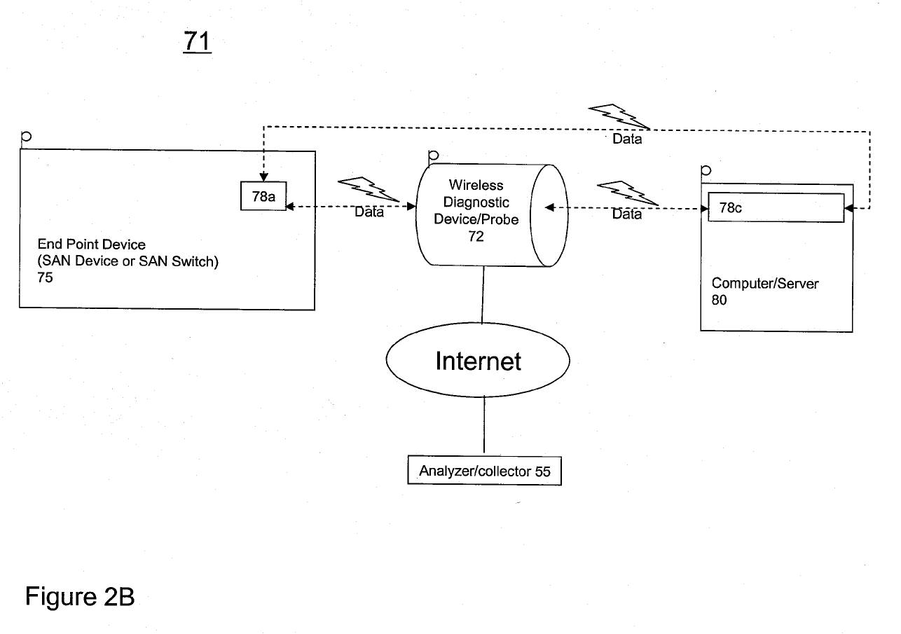

In the following FIGS. 2A-5 and 7, various schematic diagrams of embodiments of wireless diagnostic system configurations are disclosed. Accordingly, these figures are only examples of such wireless diagnostic system configurations, and are not intended to be limiting or strictly construed to require each and every aspect disclosed in connection therewith. As such, it should be recognized that various modifications can be made to the embodiments disclosed in the figures, within the scope of the present invention. Also, the schematic representations should not be construed in any limiting manner to the arrangement, shape, size, orientation, and/or presence of any of the aspects disclosed in connection therewith. For example, it should be apparent that the various data communication pathways (e.g., Data, smart data, and query data) are merely illustrative and the embodiments of wireless diagnostic systems can operate with any single data communication pathway or a combination of such pathways. With that said, a more detailed description of exemplary diagnostic systems and equipment that can facilitate wireless diagnostic analysis in accordance with the present invention is now provided.

FIG. 2A is a schematic diagram that illustrates an embodiment of a wireless diagnostic system 70A. System 70A includes a WDD/probe 72 in wireless communication on one end with a storage unit 74, such as an end point device for example, and also with an analyzer/collector 55 and base/hop/repeater 53. Thus, WDD/probe 72 can transmit information to any other device in the system. WDD/probe 72 and end point device 74 can both also communicate with a computer/server 80.

Storage unit 74 includes a plurality of data storage devices 76. Each of the storage devices 76 can be outfitted with hardware and software for wireless communications. For example, in a SAN environment, storage unit 74 may include over 200 storage devices 76. Storage unit 74 also includes a wireless transceiver 78a, which can be comprised of independent or integrated hardware or software for converting physical data transmissions to wireless data transmissions. Accordingly, wireless transceiver 78a allows storage unit 74 to transmit diagnostic data, such as self-monitoring analysis and reporting technology (“SMART”) data, about the operations and functionalities of the network storage device to wireless network storage WDD/probe 72. Also, the transceiver 78a can send diagnostic data about its own functionalities to the WDD/probe 72, where such diagnostic data can include power level monitoring, modulation parameters, and the like.

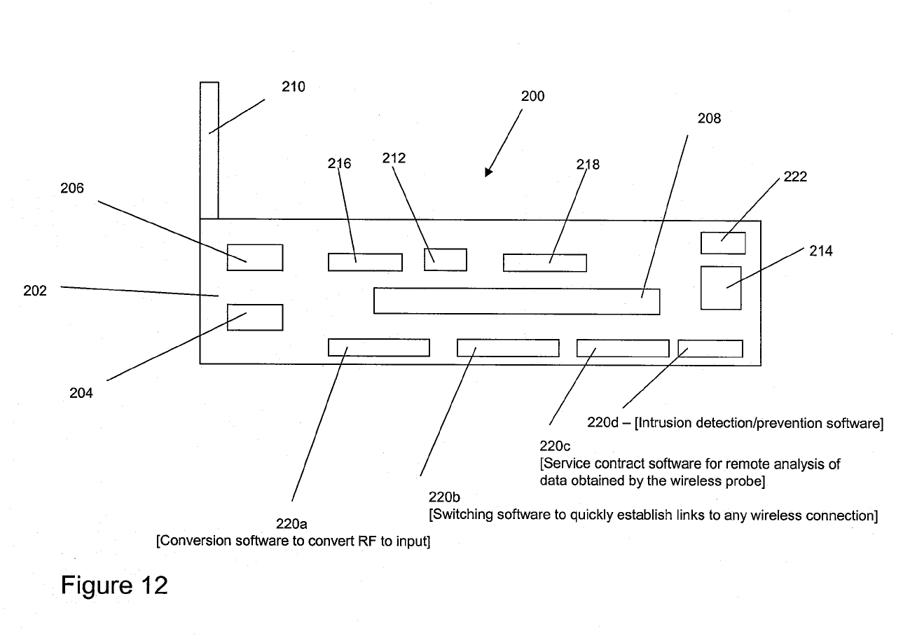

Generally, WDD/probe 72 monitors a channel to determine if wirelessly transmitted data is present on the channel, and, if detected, receives the wirelessly transmitted data from the channel. In addition, WDD/probe 72 can send a query to wireless transceiver 78a to request the diagnostic data. Further, WDD/probe 72 can actually retrieve the wirelessly transmitted data instead of passively waiting for it. Accordingly, WDD/probe 72 can include a wireless transceiver 78b located on the WDD/probe for receiving and transmitting wireless communications. Further details of an exemplary WDD/probe 72 are disclosed below with reference to FIG. 12. While a wireless transceiver 78b is not shown in other drawings illustrating a WDD/probe 72, the presence of antenna symbol 51 indicates that that component has a wireless transceiver in order to communicate data wirelessly. This should not be construed to mean that other components that do not show an antenna symbol 51 do not have wireless capabilities.

In accordance with the present invention, some of the various types data that data storage unit 74 may communicate with WDD/probe 72 relates to storage device fitness test (“DFT”) and/or self-monitoring analysis and reporting technology (“SMART”), which are storage device diagnostic tools or data. These diagnostic tools can provide error logging and self-test capabilities. Accordingly, storage unit 74 can periodically, randomly, or upon request from WDD/probe 72, transmit the DFT and/or SMART data to WDD/probe 72. In one embodiment, the data transmitted to WDD/probe 72 is collected by an analysis card 82 in storage unit 74. For example, card 82 can be a daughter card that plugs into a larger mother board.

FIG. 2A illustrates that in one embodiment, the SMART data collected by card 82 can be transmitted to WDD/probe 72 via wireless transceiver 78a. Other embodiments for transmitting SMART data are disclosed below. Such embodiments illustrate that: (1) different types of data can be transmitted from an end point device at the same time or at different times; and (2) data can be transmitted from an end point device using various pathways so that, in some embodiments, more than one component in the end point device is wirelessly enabled.

Wireless transceiver 78a in storage unit 74 can obtain any other statistics or other information related to the operation of storage unit 74, in addition to the types of data disclosed above, and wirelessly transmit such data to WDD/probe 72 for analysis by analyzer/collector 55. Analyzer/collector 55 can then analyze the data and generate reports which can be sent remotely to an administrator. The analyzer/collector 55 can also generate control signals that are sent back to WDD/probe 72, which passes the control signals to wireless transceiver 78a in the storage unit 74.

If WDD/probe 72 sends control signals back to storage unit 74, wireless transceiver 78a can communicate with hardware and/or electronics, including circuitry and/or software, capable of receiving the control signals and acting upon the control signals. For example, the electronics may include, but is not limited to, one or more actuators, temperature control devices, power control devices, motors, or other systems controllers, and the like. As such, the end point device can be controlled remotely via WDD/probe 72. When the control signals are issued from computer/server 80, the computer/server 80 can send the control signals through WDD/probe 72, or, alternatively, computer/server 80 can also include a wireless transceiver 78c to send the control signal directly to the wireless transceiver 78a of storage unit 74.

While WDD/probe 72 can receive diagnostic data and transmit control signals, in one embodiment, WDD/probe 72 can also save and retain the data that is being received or transmitted. WDD/probe 72 may also have analysis capabilities to use this saved information and then to base subsequent decisions on analyses performed. For example, in one embodiment, WDD/probe 72 can receive multiple data points during an analysis period and can analyze the data points to determine whether the data point has changed over time. When a particular data storage device 76 exhibits a deviating behavior pattern, this suggests to the WDD/probe 72 that a deteriorating functionality may be occurring. WDD/probe 72 can then take precautionary measures such as send a control signal back to storage unit 74 to attempt to correct the problem. Alternatively, WDD/probe 72 could flag the storage device 76 as being susceptible to imminent catastrophe, service and/or replacement, and send a report to computer or server 80.

In yet another embodiment, WDD/probe 72 can be integrated or coupled with analyzer/collector 55, eliminating the need for base/hop/repeaters 53 disclosed above in FIG. 1. As such, the WDD/probe 72 can be physically connected to the analyzer/collector 55 via a physical transmission medium such as a copper wire or fiber-optic cable.

In addition, as shown in FIG. 2A, computer/server 80 can transmit and receive I/O or read/write data to and from storage devices 76. Thus, computer/server 80 can be accessing and writing data wirelessly. In one embodiment, data, such as read/write data for example, is transmitted and/or received via WDD/probe 72. That is, read/write data is sent wirelessly to WDD/probe 72 to be written onto storage devices 76. Data can also be read remotely from storage devices 76 via WDD/probe 72. In another embodiment, a wireless transceiver 78c on computer/server 80 can communicate wirelessly with wireless transceiver 78a on storage unit 74. The read/write data may be transmitted to any wireless transceiver in storage unit 74 including directly to storage devices 76 if they are equipped with wireless transceivers.

Such wireless capabilities can produce additional advantages. For example, in one embodiment, the storage unit 74 could be configured to be a modular storage structure by providing a storage device enclosure sized and shaped depending on the type and number of storage devices it will hold. The storage device enclosure would also contain wireless transceivers so that the storage device enclosure can act as a stand-along storage unit that is wirelessly enabled. For example, the storage device enclosure could include power components, a fan, and a wireless transceiver and antenna. The enclosure could also include a RAID controller, storage cache, and other compartments for additional components depending on design specifications. In order for a computing device to operate these modular storage structures, the computing device could boot off a local PROM, containing enough memory to boot up the hardware and IP stack. An administrator could then control, protect, clean, backup and otherwise monitor the modular storage structures remotely. Since a storage device enclosure could be constructed for various types of storage devices, the storage device enclosure could retrofit existing storage devices, such as hard storage devices already in use, making implementation of the wireless feature simple. Further description regarding a variation of this embodiment is included herein with reference to FIG. 8B.

In another embodiment, the storage unit 74 can include synchronization capabilities through a cache front end. Synchronization capabilities enable the mirroring of storage devices 76 within the storage unit 74 as well as mirroring of storage devices positioned at remote locations using wireless data transmissions. For example, a first storage device 76 can operate so as to respond to users or operating systems that are accessing and/or using read/write files or program applications. Concurrently, a second storage device 76 could receive data in order to mirror the first storage device 76, wherein the second storage device 76 is used by an administrator for backups, archives, and the like. As such, the mirroring of the first storage device 76 to the second storage device 76 could be done by physical data transmission or wireless data transmission. Additionally, a third storage device (not shown), which is another storage device within the network located about 2 miles to about 5 miles away, could additionally mirror the first storage device 76. As such, the wireless communication capabilities disclosed herein could provide for mirroring data storage devices so that the data is retained in multiple storage devices at different locations.

In another embodiment, the third storage device, or other remote storage device, could be used as a roaming storage device. As such, the storage device is configured to be portable so as to be capable of roaming into and out of the wireless communication network. When the roaming storage device comes into range, it will automatically synchronize all changes since the previous synchronization. This process would enable the new data entered into the roaming storage device to be stored within the storage unit, and all relevant new data entered into a certain storage device, such as the first storage device 76 or the second storage device 76 to then be wirelessly transmitted to the roaming storage device.

While FIG. 2A illustrates that SMART data is being communicated with WDD/probe 72, it is also possible for WDD/probe 72 to detect other data, such as read/write data, that is being transmitted between storage unit 74 and computer/server 80. In this manner, WDD/probe 72 could operate as a network TAP. In addition, WDD/probe 72 could be used to duplicate and/or redirect the read/write data to another storage structure, to enable the mirrored storage device system discussed above. Thus, read/write data could be communicated to remote mirrored data structures via WDD/probe 72, storage unit 74, and/or computer/server 80.

The foregoing description of FIG. 2A illustrates that any end point device and wireless diagnostic device/probe can be configured to be wireless to allow a user access to information passing through or being detected by the end point device or wireless diagnostic device/probe. Being able to wirelessly communicate with a wireless transceiver on an end point device and/or wireless diagnostic device/probe enables a local or remote user to determine what information will be sent wirelessly. A user will also be able to more effectively analyze a diagnostic system and/or issue control signals.

This ability to wirelessly access end point devices and/or diagnostic devices/probes is reflected in one embodiment where WDD/probe 72, for example, is configured to allow a user to upload firmware and/or software to the WDD/probe. That is, the WDD/probe 72 can receive firmware and/or software upgrades from the user, which can be supplied through an interface or port on the WDD/probe 72. In one embodiment, a user can issue a single command that upgrades all diagnostic devices/probes in the network at the same time.

The wireless diagnostic systems disclosed herein provide increased abilities to configure a diagnostic system more efficiently and with more capabilities than were theretofore possible. Additionally, the cost benefit realized by providing wireless diagnostic functions is dramatic. Physical transmission media such as copper cables or fiber optic cables are expensive, and in some cases, require expensive connectors or interface adapters. Furthermore, particularly in the case of optical cables, installation requires great care. If there are any kinks, misalignments or ill-fitted connections, the optical transmission medium will not work efficiently. Often the installation personnel are not well-versed in the care that is needed in fitting optical connections. Further, the connection must often be tested to ensure proper transmission and integrity of the transmission medium. As such, the setup of a network or a data center with any physical transmission medium can be cost prohibitive or severely drain the financial resources of the enterprise.

In addition, after installation, often one of the first steps an administrator will advise when diagnosing an inefficiently operating network is to exchange the physical communication medium, such as by replacing a fiber optic cable. This requires additional spare cables or lines to be on hand in case of network failure, further increasing the cost of maintaining a network or system. Being able to eliminate even this step of determining where the problem in a system communication lies is a benefit to users and/or system administrators. Thus, the wireless diagnostic systems of the present invention not only drastically reduce the cost of installation and maintenance, but also can greatly reduce and/or eliminate the problems of installing and ensuring that diagnostic systems operates properly.

FIG. 2B illustrates another embodiment of a wireless diagnostic system 71. Accordingly, an end point device 75, which can be a SAN device, SAN switch, or the like, is in wireless communication with a server 80. The end point device 75 and server 80 are each outfitted with wireless transceiver 78a, 78c, respectively, in order to facilitate the wireless communication therebetween. Additionally, a WDD/probe 72 is included within the wireless diagnostic system 71 in order to receive at least a portion of the data being transmitted between the end point device 75 and the server 80. This arrangement allows the WDD/probe 72 to acquire any data, such as diagnostic data, that can render information about the performance of the end point device 75 and/or server 80. Moreover, the WDD/probe 72 can acquire all of the data being transmitted between the end point device 75 and the server 80, and act as a repeater so as boost the transmissions to the receiving device. In this manner, the end point device 75 and the server 80 indirectly communicate by first passing the data through the WDD/probe 72. FIG. 2B also illustrates that WDD/probe 72 can communicate with analyzer/collector 55 via a network, such as the Internet.

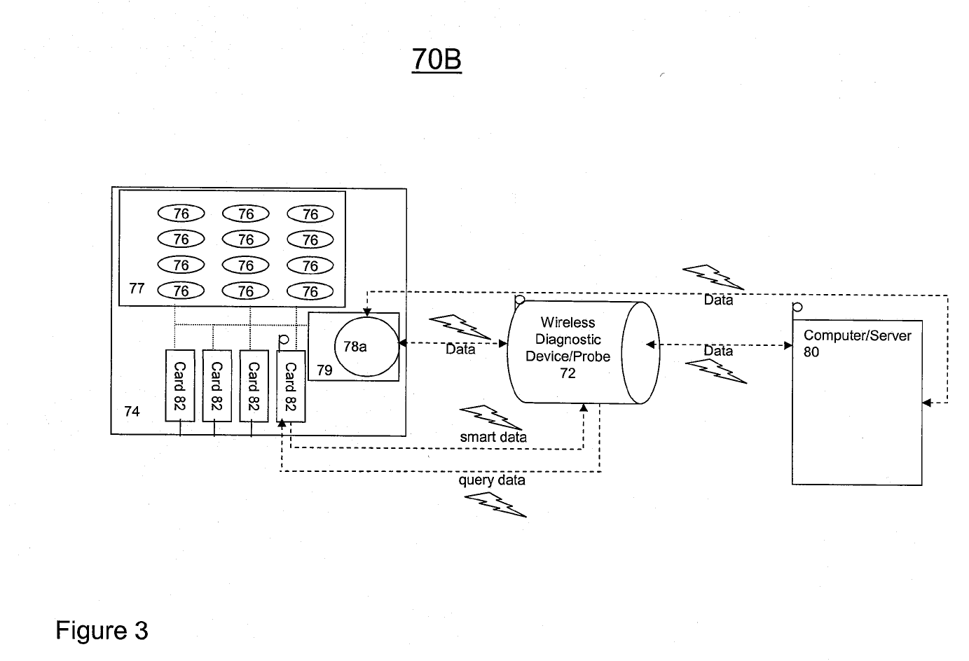

FIG. 3 is a schematic diagram that illustrates another embodiment of a wireless diagnostic system 70B. In this embodiment, storage unit 74 can employ more than one wireless transmission pathway. Thus, storage devices 76 can send data, such as read/write data, to wireless transceiver 78a, which can communicate the data to WDD/probe 72. In addition, cards 82 can each comprise a wireless transceiver daughter card to communicate data with WDD/probe 72. Wireless transceiver daughter card 82 can include electronics and/or software that can implement transmission logic to enable communication over a network. Example standards and protocols include, but are not limited to, Fibre Channel, GIGE, ISCSI, and the like. Wireless transceiver daughter card 82 can use, for example, Structure Management Information (SMI) protocol to transmit and/or receive data to and from WDD/probe 72. SMI protocol allows dissimilar devices to communicate by ensuring that those devices use a universal data representation for all management information.

Accordingly, wireless transceiver daughter card 82 can collect data about the storage devices 76 or overall performance of storage unit 74 and transmit such diagnostic data, such as SMART data for example, to WDD/probe 72. In some embodiments, wireless transceiver daughter card 82 contains circuitry to aggregate diagnostic data from other non-wirelessly enabled daughter cards 82 and then communicate with WDD/probe 72. In this way, wireless transceiver daughter card 82 acts as a liaison for the other cards. However, multiple cards 82 may be wireless transceiver daughter cards and may each be used to communicate separately with WDD/probe 72. Both wireless transceiver 78a and wireless transceiver daughter cards 82 can also be configured to send both data, such as read/write data, and diagnostic data.

FIG. 3 also illustrates that, in one embodiment, storage devices 76 represent a Redundant Array of Independent Disks (RAID), and can be configured in, for example, a RAID array, which provides for spreading or striping data across multiple hard storage devices for redundancy, higher performance, and greater scalability. If one disk fails, the system continues to operate by accessing the redundant data on the other disk storage devices. The failed storage device can be removed and replaced (“hot plugged”) and the new storage device is automatically reconstructed by using the information on the remaining storage devices in the RAID group. All of this can be done without any host, operator, or operating system involvement.

In embodiments where storage devices 76 form a RAID, a RAID controller 77 is provided to control the layout and format of the data. In the embodiment of FIG. 3, RAID controller 77 is configured to be wirelessly enabled by configuring the RAID controller with a wireless transceiver 78a. Wireless transceiver 78a can be an additional component retrofitted or otherwise added to RAID controller 77. Alternatively, wireless transceiver 78a can be integrated with RAID controller 77. Accordingly, wireless transceiver 78a allows RAID controller 77 to transmit data, such as read/write data, and, optionally, diagnostic data about the operations and functionalities of the network storage device, to WDD/probe 72.

In another embodiment, the RAID controller 77 communicates with a wireless transceiver daughter card 82. As discussed above, the RAID controller 77 provides the data, such as read/write data, and, optionally diagnostic data, such as SMART data, to the controller 79 so that the wireless transceiver 78a can communicate the data to WDD/probe 72 and/or computer/server 80. Thus, RAID controller 77 can communicate with both wireless transceiver 78a and wireless transceiver daughter card(s) 82 so that, in one exemplary configuration, RAID controller 77 can transmit data, such as read/write data, via the wireless transceiver 78a, and transmit diagnostic data, such as SMART data, via the wireless transceiver daughter card 82.

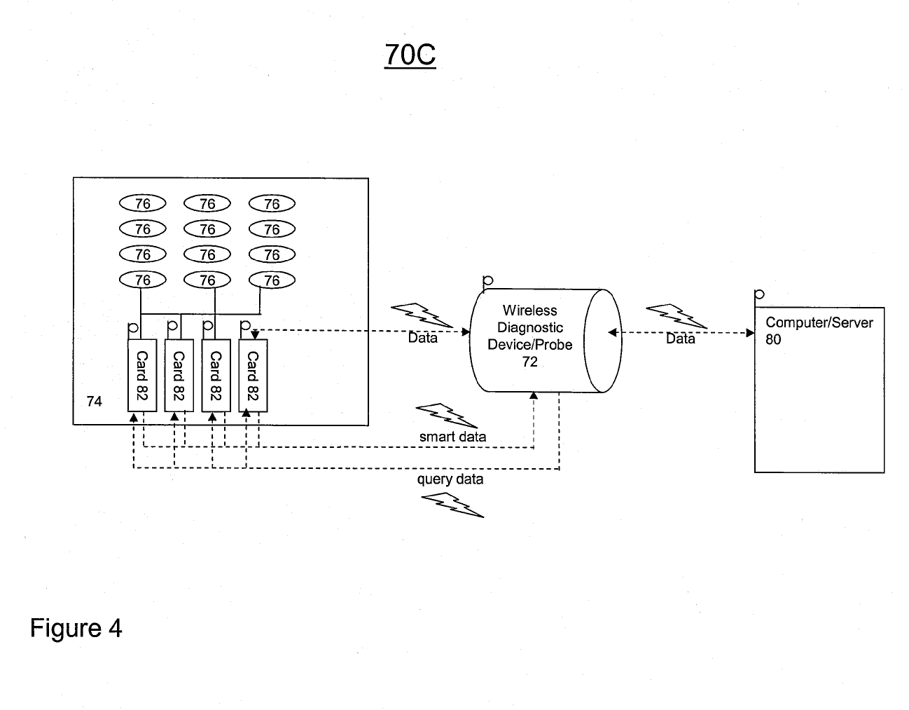

FIG. 4 is a schematic diagram that illustrates another embodiment of a wireless diagnostic system 70C. In this embodiment, all of cards 82 have transceivers to form a group of wireless transceiver daughter cards. In one embodiment, a card 82 specifically dedicated for wireless transmissions could similarly be used. As such, card 82 could eliminate the need for wireless transceiver 78a (FIGS. 2 and 3) and can wirelessly transmit all of the data, including SMART data and/or read/write data, to the WDD/probe 72 and/or the computer/server 80. Contrasting FIGS. 3 and 4, one or all of cards 82 can be outfitted with hardware and software for wireless communications. FIG. 4 also illustrates that, in at least some instances, cards 82 communicate with storage devices 76 via electrical connections.

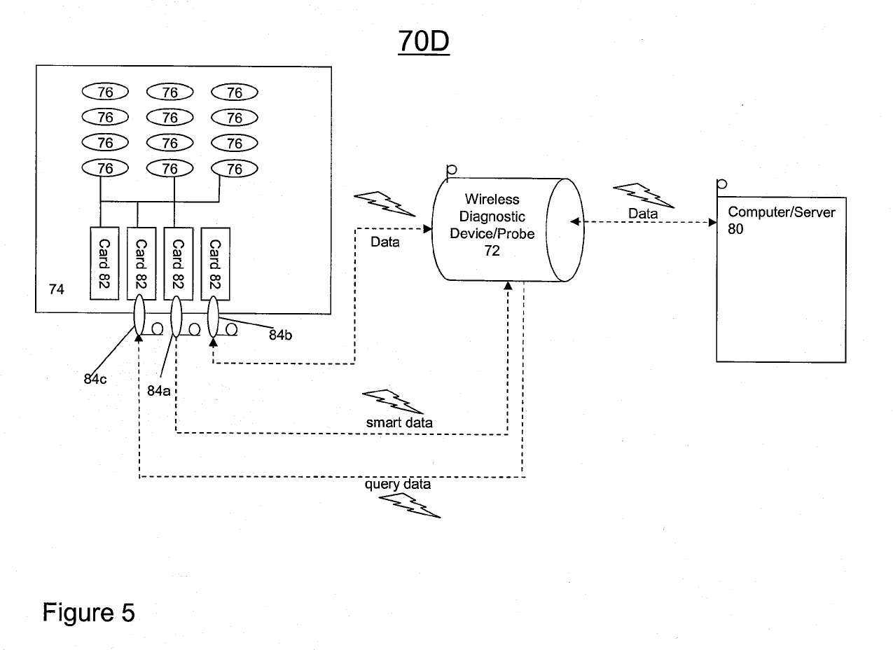

FIG. 5 is a schematic diagram that illustrates another embodiment of a wireless diagnostic system 70D in accordance with the present invention. In this embodiment, storage unit 74 includes cards 82 that are each in communication with a respective wireless transceiver module 84, such as, for example, a wireless GBIC transceiver module, wireless SFP transceiver module, wireless SFF transceiver module, wireless XFP transceiver module, and like wirelessly-enabled pluggable or form factor transceiver modules. Wireless transceiver modules 84 may also communicate with other electrical and/or optical circuits besides cards 82, such as any printed circuit board or flexible circuit structure for example. These wireless transceiver modules 84 can be configured to conform to industry standards, but communicate with WDD/probe 72 using wireless communication rather than physical transmission media. By conforming to industry standards, the wireless transceiver module 84 can be easily implemented in existing communication systems.

Accordingly, FIG. 5 illustrates that one wireless transceiver module 84a could be used to transmit SMART data to the WDD/probe 72, and another wireless transceiver module 84b can be used to transmit application data such as read/write data to the computer/server 80. Additionally, yet another wireless transceiver module 84c can receive a query from the WDD/probe 72 in order to generate and/or transmit the diagnostic data back to the WDD/probe 72. However, other configurations can be applied, such as having all data, such as diagnostic data, read/write data and queries, pass through a single wireless transceiver module 84. By designing the wireless transceivers as a pluggable transceiver module, existing storage units 74 that are already equipped with, or communicate with, cards 82 that are configured to couple with existing pluggable transceiver modules will easily receive wireless transceiver modules that can plug directly into cards 82.

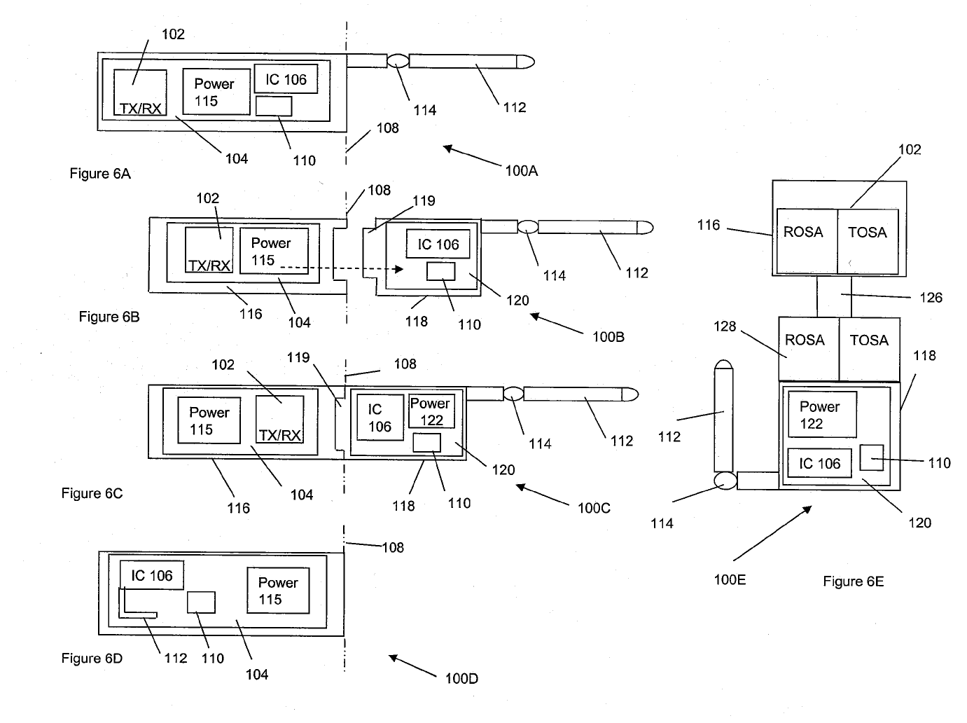

With reference to FIGS. 6A through 6D, various embodiments of wireless transceiver modules or wireless transceiver adapters 100A-100E such as, but not limited to, wireless GBIC, SFF, SFP, XFP, 1×9, 300-pin, parallel fiber optic, XPAK, X2, and XENPAK transceiver modules, will be disclosed in further detail. As understood to those of skill in the art, GBIC, SFF, SFP, XFP, 1×9, 300-pin, parallel fiber optic, XPAK, X2, and XENPAK refer to form and sizing requirements and/or configurations for transceivers and not to the particular technology on which they are based. Thus, these sizing requirements can apply equally to, for example, both optical transceivers and electrical transceivers.

Starting with FIG. 6A, a wireless transceiver module 100A having both transceiver components and wireless components is disclosed. Wireless transceiver module 100A can include transceiver components 102 communicating with a printed circuit board 104 and an integrated circuit 106. In the embodiment of FIG. 6A, the transceiver module 100A includes the integrated circuit 106 on the printed circuit board 104, illustrating that the wireless components can be included integrally with a transceiver module. In some embodiments, transceiver components 102 may be optical transceiver components such as, but not limited to, a TOSA or ROSA. In other embodiments, transceiver components 102 may be configured for electrical transmission, such as in the case of a copper-wire transceiver. In other embodiments, transceiver components may not even be required where wireless transceiver module 100A can communicate through an electrical interface with the host device (see FIG. 6D).

The embodiment of FIG. 6A illustrates that the wireless transceiver module 100A can be configured to fit in an existing transceiver port in a host device, the host device being indicated by reference numeral 108. Thus, the wireless transceiver module 100A can be configured to be pluggable into existing network devices to convert data to wirelessly transmitted data.

Integrated circuit 106 can be any electrical circuit that provides wireless capability such as, but not limited to, an application-specific integrated circuit (ASIC), Monolithic Microwave Integrated Circuit (MMIC), or Radio Frequency Integrated Circuit (RFIC). Additionally, a controller 110 may be provided on printed circuit board 104 to facilitate the operation of the wireless transceiver module 100A and to enable data conversion between physically transmitted data and wirelessly transmitted data. In one embodiment, controller 110 is in the form of software written onto ROM, PROM or EPROM or a combination of software and hardware, such as firmware.

Wireless transceiver module 100A also includes an antenna 112 electrically connected to the integrated circuit 106. Antenna 112 can be connected to any location on the housing of wireless transceiver module 100A, such as near an edge of the housing or centered with the housing. Further, while antenna 112 is shown exterior to the wireless transceiver module 100A housing, antenna 112 could be configured within the interior of the housing using, for example, a flexible strip embedded on a laminate layer or other printed circuit board (see FIG. 6D). In one embodiment, as shown in FIG. 6A, antenna 112 can be connected to the housing of wireless transceiver module 100A via a rotatable hinge 114. Hinge 114 enables antenna 112 to be moveable in any direction so that when wireless transceiver module 100A is inserted into a port, antenna 112 can be adjusted as desired.

Additionally, the printed circuit board 104 includes a power assembly 115. The power assembly 115 can receive power from the GBIC port and/or the host device containing the GBIC port. Thus, the host device can supply power to the power assembly 115 so that the GBIC with its wireless components can function properly.

FIG. 6B shows a wireless transceiver module assembly 100B similar to module 100A so that like elements will be referred to with like reference numerals. Wireless transceiver module assembly 100B comprises an existing non-wireless transceiver module 116 that can be converted to transmit wireless signals using a wireless transceiver adapter 118 that is configured to couple to the non-wireless transceiver module 116. Wireless transceiver adapter 118 can be fitted with an interface 119 that enables the wireless transceiver adapter 118 to be connected with the connector ports located on non-wireless transceiver module 116. For example, where non-wireless transceiver module 116 is configured to receive optical connectors, interface 119 can be configured to replicate optical connectors and, if necessary, transmit optical signals into an existing optical non-wireless transceiver module 116. Non-wireless transceiver module 116 has a printed circuit board 104 and wireless transceiver adapter 118 has a separate printed circuit board 120. Integrated circuit 106 is thus located on printed circuit board 120. FIG. 6B shows non-wireless transceiver module 116 and wireless transceiver adapter 118 before coupling together while FIG. 6C shows wireless transceiver adapter 118 coupled into non-wireless transceiver module 116.

Thus, wireless transceiver adapter 118 can be formed separately and sold separately from non-wireless transceiver module 116. Wireless transceiver adapter 118 may be beneficial where, for example, the wireless components may not fit within the size requirements of standardized transceivers. This arrangement allows for retrofitting existing non-wireless transceiver modules 116 while still allowing wireless transceiver adapter 118 to include all of the software and hardware necessary for wireless transmissions. Thus, the wireless transceiver adapter 118 can provide the wireless communication components while the non-wireless transceiver module 116 transmits data from the host device 108 to the wireless transceiver adapter 118.

In embodiments where non-wireless transceiver module 116 includes optical components, interface 119 can provide optical communication between non-wireless transceiver module 116 and wireless transceiver adapter 118. Alternatively, where non-wireless transceiver module 116 includes only electrical components, interface 119 can provide electrical communication between non-wireless transceiver module 116 and wireless transceiver adapter 118. In some embodiments, as shown in FIG. 6B, power assembly 115 located on printed circuit board 104 delivers power to wireless transceiver adapter 118. Alternatively, in certain embodiments, power may not be available from host device 108 so that external power may be required (see FIG. 6C).

FIG. 6C shows a wireless transceiver module assembly 100C that includes a non-wireless transceiver module 116 that can be wirelessly enabled using a wireless transceiver adapter 118 similar to FIG. 6B, so like elements will be referred to with like reference numerals. FIG. 6C illustrates wireless transceiver adapter 118 coupled into the non-wireless transceiver module 116. However, in this embodiment, a power assembly 122 is located on wireless transceiver adapter 118 to deliver external power to the wireless transceiver adapter 118, unlike the embodiment of FIG. 6B where the power assembly 115 delivers power to the wireless transceiver adapter 118.

FIG. 6D also shows another embodiment of a wireless transceiver module 100D with like elements being referred to with like reference numerals. FIG. 6D shows that in wireless transceiver module 100D, the wireless components can be formed integrally with the module. However, the wireless components are located on the interior of the wireless transceiver module 100D so that the wireless transceiver module can conform to form factor requirements. In this embodiment, transceiver components 102 may not be required and are not shown where wireless transceiver module 100D interfaces with host device 108 using only electrical components. In addition, FIG. 6D illustrates that antenna 112 can be formed on printed circuit board 104, allowing the wireless components to be located anywhere in the wireless transceiver module 100D so that the module does not protrude from the host device 108.

FIG. 6E shows another embodiment of a wireless transceiver module system 100E comprising an existing non-wireless transceiver module 116 and a wireless transceiver adapter 118. Non-wireless transceiver module 116 includes optical transceiver components 102, disclosed as a ROSA and TOSA. ROSA and TOSA are configured to couple to an optical medium 126, such as a section of fiber optic cable, for receiving and transmitting optical signals. Wireless transceiver adapter 118 includes printed circuit board 120 having integrated circuitry 106, controller 110 and power 116 and communicating with antenna 112 to enable the adapter 118 to convert optical signals to outgoing wireless signals. Power assembly 122 can include a battery or a connection to an external power supply.

Wireless transceiver adapter 118 also includes transceiver components 128 to receive and transmit optical signals through cable 126. The transceiver components 128 can be used to convert optical to electrical signals. In addition, integrated circuitry 106 converts the electrical signals to wireless signals. Wireless transceiver adapter 118 could be permanently connected to optical cable 126 or could include a first port (not shown) for connecting to optical cable 126. Thus, the wireless transceiver adapter 118 is connected externally to a non-wireless transceiver module 116 via cable 126. Wireless transceiver adapter 118 can be configured with multiple transceiver components 128 to connect to multiple non-wireless transceiver modules 116 so that a single wireless transceiver adapter 118 can be used to make multiple transceivers wirelessly enabled.

While general descriptions of wireless transceiver modules and wireless transceiver adapters have been provided in connection with FIGS. 6A-D, one skilled in the art should appreciate that not all of the various components and subcomponents are required to be present as shown for providing the proper functionality. As such, the elements and aspects disclosed in connection with FIGS. 6A-D can be included, excluded, modified, and/or combined. Additionally, it is possible that the elements and aspects could be incorporated in a host device, computing system, or card that operates with the wireless transceiver modules and/or wireless transceiver adapters. For example, the integrated circuitry 106 and controller 110 could be combined into a single element, or optionally, provided as part of the host device, host transceiver module, and/or the like.

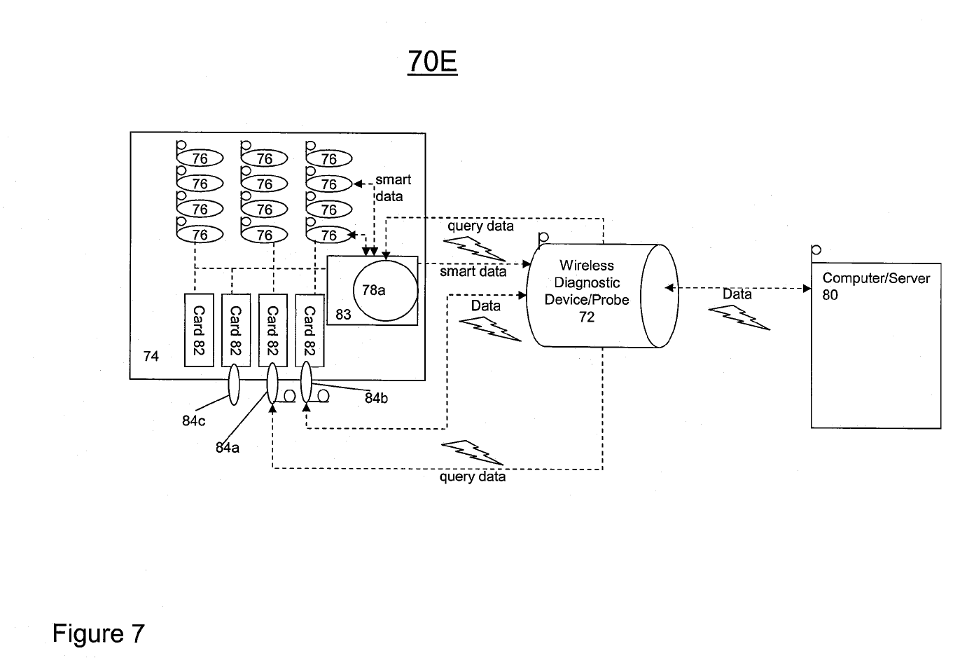

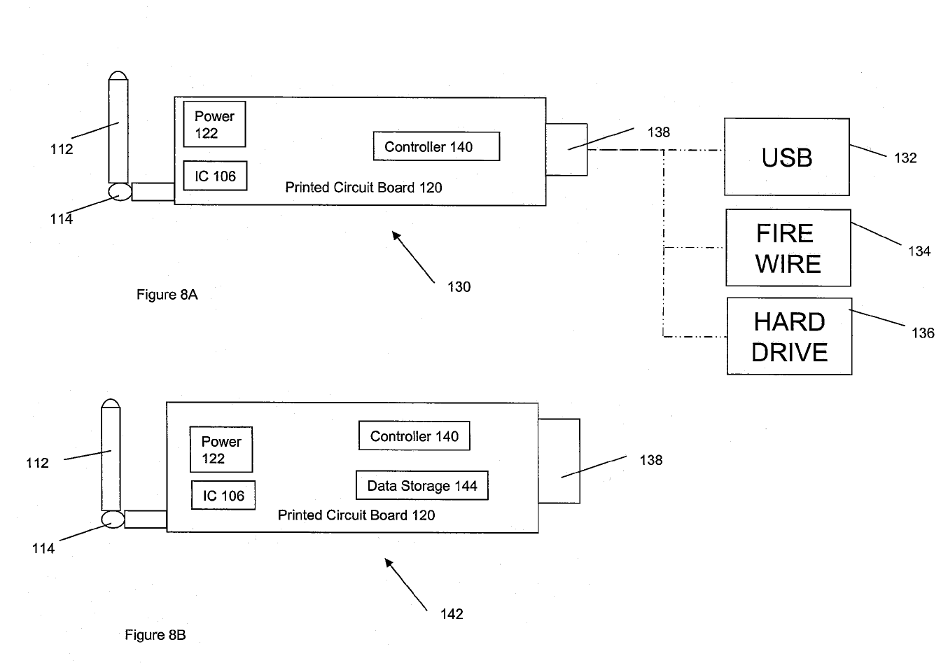

Turning now to FIG. 7, another embodiment of a wireless diagnostic system 70E is disclosed. This configuration includes storage devices 76, such as a hard storage device, data platter, disk storage device, magnetic storage device, optical storage device, or the like, that have integrated wireless transceivers configured to operate at low power. As such, the low power wireless transceiver integrated in the storage devices 76 communicate with wireless transceiver 78a via a repeater 83. The repeater 83 operates similarly to the base/hop/repeaters 53 of FIG. 1 by receiving lower powered transmissions, and enabling the wireless transceiver 78a to boost the power and transmit a high powered signal. The wireless transceiver 78a can then retransmit the signal, for example, at high power for longer-distance transmission to WDD/probe 72. Either the low power wireless transceivers on storage devices 76 or high power wireless transceiver 78a can be powered off when not in use. This embodiment reduces, or can eliminate, interference between wireless devices, wireless components and/or communications of storage unit 74. Exemplarily, the low power wireless transceivers integrated with storage devices 76 can communicate DFT and/or SMART data as well as any other type of data to wireless transceiver 78a.

Additionally, the WDD/probe 72 can query for the diagnostic data, such as SMART data, by sending a query to the wireless transceiver 78a and/or the wireless transceiver module 84a in communication with card 82. There may be instances where the wireless transceiver 78a is able to receive a query and transmit the corresponding diagnostic data. On the other hand, there may be instances where the wireless transceiver 78a is incapable of concurrently transmitting and receiving such data. Thus, having the wireless transceiver 78a and/or wireless transceiver module 84c receive a query can enhance the functionality of the storage unit 74, storage devices 76, and the WDD/probe 72.

In addition, there may be instances where wireless transceiver module 84b is capable of communicating data, such as read/write data, to the computer/server 80, as well as communicating diagnostic data to the WDD/probe 72. However, by having multiple wireless transceiver modules 84 capable of independently or cooperatively communicating data with the WDD/probe 72 and/or computer/server 80, the wireless diagnostic system 70E can operate in a more efficient manner. Thus, the wireless transceiver modules 84 can independently communicate read/write data with the computer/server 80 or diagnostic data with the WDD/probe 72, or cooperatively distribute all data to the proper wireless device.

In yet another embodiment, storage devices 76 can communicate with wireless transceiver 78a via a physical transmission medium. Using electrical or optical connections, the storage device 76 can still communicate data to wireless transceiver 78a, which can aggregate the data and send it to WDD/probe 72.

The above examples for wireless diagnostic systems 70A-70E illustrate a storage unit 74 as an exemplary end point device. However, storage unit 74 could easily be replaced with any of the end point devices disclosed above with reference to FIG. 1 as well as other end point devices understood by those of skill in the art. The placement of wireless transceiver 78a as well as the implementation of wirelessly-modified devices will vary depending on the hardware and circuitry of the particular end point device and the particular type of diagnostic analysis or function being performed.

FIG. 8A illustrates an embodiment of a wireless transceiver adapter 130 that is configured to enable an existing end point device to be capable of the wireless communications disclosed herein. As disclosed in FIG. 8A, the wireless transceiver adapter 130 is configured to plug into an existing port on an end point device. For example, where an end point device is a computer system 58 (FIG. 1), the wireless transceiver adapter 130 can be selectively coupled to a USB port on a USB device 132, a port on a fire wire device 134 and a port on a hard storage device enclosure 136. As such, a USB device, fire wire device and hard storage device enclosure can be converted to be wirelessly enabled. A wirelessly enabled port, as such, would enable the device to continue to transmit data as normal, but would also be able to communicate the transmitted data to wireless devices via wireless transceiver adapter 130.

Similar to the wireless transceiver modules disclosed herein, the wireless transceiver adapter 130 includes a printed circuit board 120, power assembly 122, and integrated circuitry 106 in communication with an antenna 112 with optional hinge 114. Wireless transceiver adapter 130 may further include controller 140. Controller 140 is configured to control the operation of the host device to which the wireless transceiver adapter is connected. Controller 140 can be implemented in the form of software written onto ROM, PROM or EPROM or a combination of software and hardware, such as firmware. Suitable controllers 140 can be developed to control various devices, such as for USB 132, fire wire 134 and hard drives 136. Controller 140 also enables, for example, the USB port to be able to function as a normal USB port and be able to send and receive other data.

Wireless transceiver adapter 130 includes an interface 138 that can be configured depending on the type of port to which adapter 130 is being applied. Thus, for USB devices, interface 138 may be configured to plug into a USB port, for hard storage device devices, interface 138 may be appropriately configured to plug into a corresponding port and so on. In one embodiment, the interface 138 can be selectively removable so that a different interface 138 can be attached to a base RF adapter 130 to reduce the manufacturing cost. However, in other embodiments, interface 138 can be integrally formed as part of adapter 130.

Power assembly 122 can enable the adapter 130 to be powered by the data cable that is plugged into USB port itself. Alternatively, as discussed above, a separate power source may be included in wireless transceiver adapter 130.

The embodiment of the wireless transceiver adapter 130 being applied to hard storage device 136, is one method of implementing the configuration of FIG. 2A and other figures where the storage devices 76 is configured to be wirelessly enabled. In this embodiment using wireless transceiver adapter 130, the adapter 130 would include a suitable interface 138 that can be adapted depending on the type of storage device 136 such as, but not limited to FC, SCSI, ATA, SATA and the like. As such, the storage device can be wirelessly-enabled simply by plugging the wireless transceiver adapter 130 into the interface of the storage device 136.

Another embodiment of a wireless storage device 142 is disclosed in FIG. 8B. This embodiment draws on the description of a modular storage device enclosure disclosed above with reference to FIG. 2A. In this embodiment, the wireless storage device 142 can include many of the same components as, for example, wireless transceiver adapter 130, and further includes data storage 144. Such data storage 144 can be any type of data storage for storing data external to an end point device. An example of the data storage 144 would be any hard disk, USB pluggable external memory sticks or thumb-drive device. As such, wireless storage device 142 may include an interface 138 that allows the adapter to be plugged into an existing hard storage device port. In the case where wireless storage device 142 contains an interface 138, it can appropriately be referred to as an adapter, similar to the other wireless transceiver adapters disclosed herein. However, storage device 142 can also be a completely stand-alone device such that it is portable. As such, an interface 138 may not be required. Where interface 138 is not present, integrated circuit 106 can be appropriately referred to as a wireless transceiver, consistent with the definitions of the present invention. Thus, the wireless storage device 142 would incorporate wireless-enabling components and data storage so that the device can retain data as well as transmit and receive data, such as read/write data or diagnostic data.

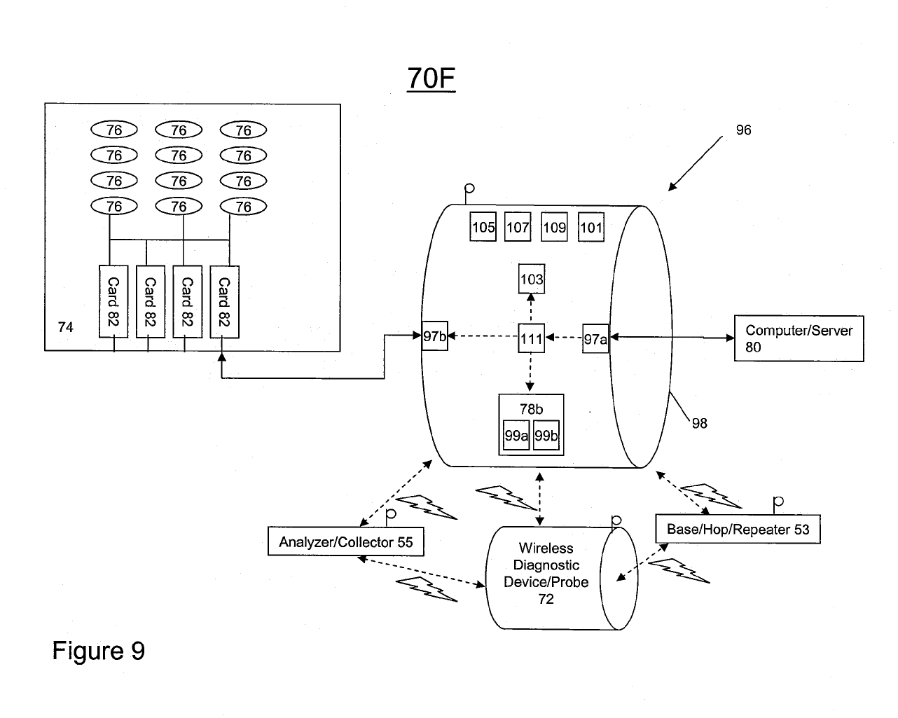

FIG. 9 illustrates another embodiment of a wireless diagnostic system 70F incorporating a network TAP 96 that can be connected to an end point device, such as a storage unit 74. The network TAP 96 can be compatible with any of the network protocols disclosed herein, and can also be compatible with any of the bandwidths disclosed herein. A network TAP generally sits between two network nodes to monitor and access the data delivered on a physical data line, such as an optical data line or an electrical data line, passing between those nodes. Generally, to install a network TAP, the data line is spliced and the network TAP is connected to the data line. The example network TAP 96 can include an input port 97a and an output port 97b disposed in a housing 98. Each of the input and output ports 97a and 97b is configured to be in communication with a data line. For example, where the input port 97a is an optical port, the input port 97a can be, for example, an SC or LC optical port configured to be coupled to a corresponding SC or LC optical plug of an optical data line. Alternatively, where the input port 97a is an electrical port, input port 97a can be an RJ-45 electrical port configured to be coupled to a corresponding RJ-45 electrical plug of an electrical data line. In some embodiments, the input port 97a and the output port 97b can be combined into a single port where the spliced data line is capable of two-way communication. Thus, the network TAP 96 shown in FIG. 9 is physically connected to the storage unit 74, and physically connected at the other end to computer or server 80.

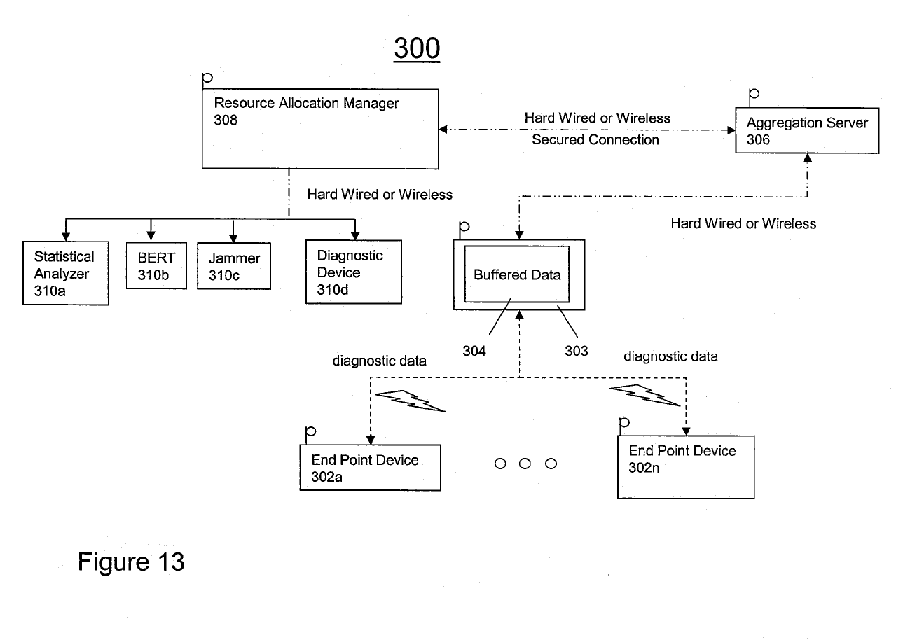

However, in contrast to conventional network TAP systems, network TAP 96 is wirelessly enabled, for example, using wireless transceiver 78b either separately connected or integrally formed, for example, in integrated circuitry of the network TAP 96. Alternatively, in place of the wireless transceiver 78b, network TAP 96 can include instead a wireless transmitter 99a or a wireless receiver 99b. Where network TAP 96 includes both the wireless transmitter 99a and the wireless receiver 99b, they function together as wireless transceiver 78b. The wireless transmitter 99a enables network TAP 96 to transmit data wirelessly to, for example, a WDD/probe 72 or base/hop/repeater 53 and/or analyzer/collector 55. The wireless transmitter 99a of the wireless transceiver 78b can transmit a copy of all or a portion of the data that passes through the network TAP 96. With reference to FIG. 1, the base/hop/repeater 53 can then pass on that data to another base/hop/repeater 53 or to an analyzer/collector 55. In one embodiment, the WDD/probe 72 treats the network TAP 96 as another end point device that the WDD/probe 72 gathers data from along with other end point devices. The wireless transmitter 99a of the wireless transceiver 78b of the network TAP 96 can also be configured to transmit data wirelessly to other network components, such as, for example, to an aggregation server 306, as disclosed herein in connection with FIG. 13.

In the disclosed embodiment, the network TAP 96 requires a power source in order for the wireless transmitter 99a and the wireless receiver 99b of the wireless transceiver 78b to transmit and receive data over one or more wireless channels. The network TAP 96, therefore, includes a power assembly 101. The power assembly 101 can provide power to network TAP 96 in a number of ways, including in the same manner as the power assembly 122 disclosed herein in connection with FIG. 6E, and other power assemblies disclosed herein.

The network TAP 96 can be spliced into a data line between one or more end point devices as discussed above, or the network TAP 96 can be attached to an ancillary data line that branches off from a data line between one or more end point devices. In either configuration, the input port 97a and the output port 97b are connected. This connection enables data to be received as input at the input port 97a, to pass through network TAP 96, and to be transmitted as output at the output port 97b. This connection between the input port 97a and the output port 97b can either function actively or passively. An “active connection” between two ports requires power in order for data to pass between the two ports. A “passive connection” between two ports does not require power in order for data to pass between two ports. For example, where the input port 97a and the output port 97b are “actively connected,” power from the power assembly 101 is necessary in order for data to pass between the input port 97a and the output port 97b. Where, however, the input port 97a and the output port 97b are “passively connected,” power from the power assembly 101 is not necessary in order for data to pass between the input port 97a and the output port 97b. The data output by output port 97b is identical to the data input into the input port 97a in either an active or passive connection, although the signal strength of the output data signal may differ from the signal strength of the input data signal. For example, in a passive connection, the signal strength of the output data signal may be less than the signal strength of the input data signal.

The wireless transmitter 99a and the wireless receiver 99b of wireless transceiver 78b can transmit and receive wirelessly transmitted data, respectively, according to any wireless standard, including, for example, IEEE 802.11. The wireless transmitter 99a of wireless transceiver 78b is also capable of translating data received at the input port 97a into wirelessly transmitted data according to any wireless standard. For example, data transmitted according to the IEEE 802.3 standard can be translated by wireless transmitter 99a into wirelessly transmitted data according to IEEE 802.11.

Network TAP 96 also can also include a monitor port 103 disposed in housing 98. The monitor port 103 functions similar to the output port 97b. Specifically, the monitor port 103 is connected to the input port 97a. This connection enables data received at the input port 97a to pass through network TAP 96 and be transmitted as output at the monitor port 103. This connection between the input port 97a and the monitor port 103 can also be passive or active, as disclosed above.

Also, network TAP 96 can include a processor 105, a memory 107, and a buffer 109. The amount of data that can be stored in memory 107 and buffer 109, and the speed and processing power of processor 105, can varying depending on the needs of the particular embodiment of network TAP 96. For example, buffer 109 can be large enough to hold approximately 2 minutes of data passing through input port 97a.

The data received over a wireless channel by wireless receiver 99b of wireless transceiver 78b may include control signals. The control signals can be stored in the memory 107 and processed by the processor 105. These control signals can be configured to, for example, instruct processor 105 to monitor the data passing through network TAP 96 for the occurrence of specific triggering events. As used herein, the term “triggering event” refers to a predetermined event that can be identified in a stream of data. For example, a triggering event may be the occurrence of: a particular bit sequence or bit pattern; an external trigger signal; a hardware or software state such as when a protocol analyzer's buffer is filled; the absence of a particular event, bit sequence or bit pattern; a particular user input; or any other suitable circumstance. When a triggering event is identified in the data passing through network TAP 96 by processor 105, processor 105 can capture a portion of the data associated with the triggering event and store the captured data in the buffer 109.

This captured data associated with the triggering event can include for example, (i) a portion of the data received before the reception of the portion of the data in which the triggering event was detected, (ii) the portion of the data in which the triggering event was detected, (iii) a portion of the data received after the reception of the portion of the data in which the triggering event was detected, or (iv) a combination of (i), (ii) and/or (iii). This captured portion of the data can additionally or alternatively include a subset of (i), (ii), (iii) and/or (iv). For example, this subset of (i), (ii), (iii) and/or (iv) can include only the headers of the packets in the data. Likewise, this captured portion of the data associated with the event can additionally or alternatively include data describing the event, such as an aggregation point identifier for the data event. In this case, while the captured portion of the data associated with the event is being updated to include data describing the event, network TAP 96 can lock the data in buffer 109 so that the data in buffer 109 cannot be transmitted by wireless transmitter 99a until the update to the data is complete. It should be understood that captured portions of the data corresponding to the multiple events can be serially identified and simultaneously stored in buffer 109 for simultaneous transmission by wireless transmitter 99a.

This captured portion of the data associated with the event can be stored in buffer 109 for eventual transmission by transmitter 99a to an aggregation server, such as the aggregation server 306, as disclosed herein in connection with FIG. 13. The aggregation server can then collect and store a portion of the data corresponding to each event. This collection and storage can be based on criteria pre-programmed into the aggregation server, or based on criteria specified by a user who has access to the aggregation server. The aggregation server is configured to make choices based on pre-programmed or user-specified criteria. These choices include, but are not limited to, sending an email, sending an SMS message, generating a report, marking the data for removal, marking the data for long term storage, or setting a severity to the event represented by the data and storing the data along with the severity of the event represented by the data. The term “severity” as used herein refers to a classification which indicates to a user the overall adverse impact of an event on a network.

As discussed above, the network TAP 96 is spliced into a data line. The network TAP 96 includes a device 111 configured to split the data received from the data line at the input port 97a into two or more data lines. The device 111 for splitting the data received from the data line at the input port 97a into two or more data lines can function as either an active connection or a passive connection, as disclosed above.

Where the network TAP 96 is configured to be spliced into an optical network, the device 111 can be an optical coupler 111. The optical coupler 111 receives as input the data received from the optical data line at the optical input port 97a. In this example, the optical coupler 111 outputs the data through three respective optical data lines to the optical output port 97b, the wireless transmitter 99a of the wireless transceiver 78b, and the optical monitor port 103. The data output by the optical coupler 111 on these three separate optical data lines is identical to the data received as input into the optical coupler 111, although the signal strength of the output data signal may differ from the signal strength of the input data signal. For example, where the optical coupler 111 is passive, the signal strength of the output data signal will be less than the signal strength of the input data signal. Alternatively, where the optical coupler 111 is active, the signal strength of the output data signal may be greater than or less than the signal strength of the input data signal.

Where the network TAP 96 is spliced into an electrical network, the device 111 for splitting the data received from the electrical data line at the input port 97a into two or more electrical data lines can be an operational amplifier 111. The operational amplifier 111 receives as input the data from the electrical data line at the electrical input port 97a. The operational amplifier 111 outputs data transmitted through three separate electrical data lines: the electrical output port 97b, the wireless transmitter 99a of the wireless transceiver 78b, and the electrical monitor port 103. The data output by the operational amplifier 111 on these three separate electrical data lines is identical to the data received at the electrical input port 97a, although the signal strength of the output data signal may differ from the signal strength of the input data signal.

WDD/probe 72 can analyze the data sent by the TAP 96 and create statistics or generate control signals based on these statistics. Alternatively, network TAP 96 can perform some of the analysis and report the results to WDD/probe 72. A plurality of TAPs 96 could be configured to report and receive data to/from a single WDD/probe 72 or base/hop/repeater 53, even though the number of wireless transceivers in the WDD/probe 72 or base/hop/repeater 53 could be less than the number of TAPs 96 with which the probe 72 or base/hop/repeater 53 is corresponding. This is possible due to the switching and/or scheduling that the WDD/probe 72 or base/hop/repeater 53 implements, disclosed further below. Further, while not shown, storage unit 74 could be wirelessly enabled by implementing one or more wireless transceivers as has been disclosed above in great detail.

Due to the potential number of wireless transceivers that can be implemented in a single end point device or in multiple end point devices within close proximity of each other, interference between or among wireless transceivers is a potential problem. However, there are a number of ways that such interference issues can be addressed. For example, diagnostic systems of the present invention can include construction of rooms housing the wireless hardware for optimum non-interference, using multi-antennae for wireless transmissions, using FHSS transmission schemes which allow a transmission to hop to a different frequency if interference is experienced, for high-speed wireless transmissions, such as transmission having a bit rate of more than 1 Gbps, using a 60-GHz band with an extremely wide bandwidth, such as 2.5 GHz, and the like. Other methods and techniques will also develop which can be applied to the present invention.

In addition, security is always an important issue to anyone operating a wireless system. However various methods exist for ensuring secure wireless transmissions including, but not limited to, secure shell tunneling, encryption, and/or any other security technology that is available or will be available in the future.

III. Exemplary Switching System

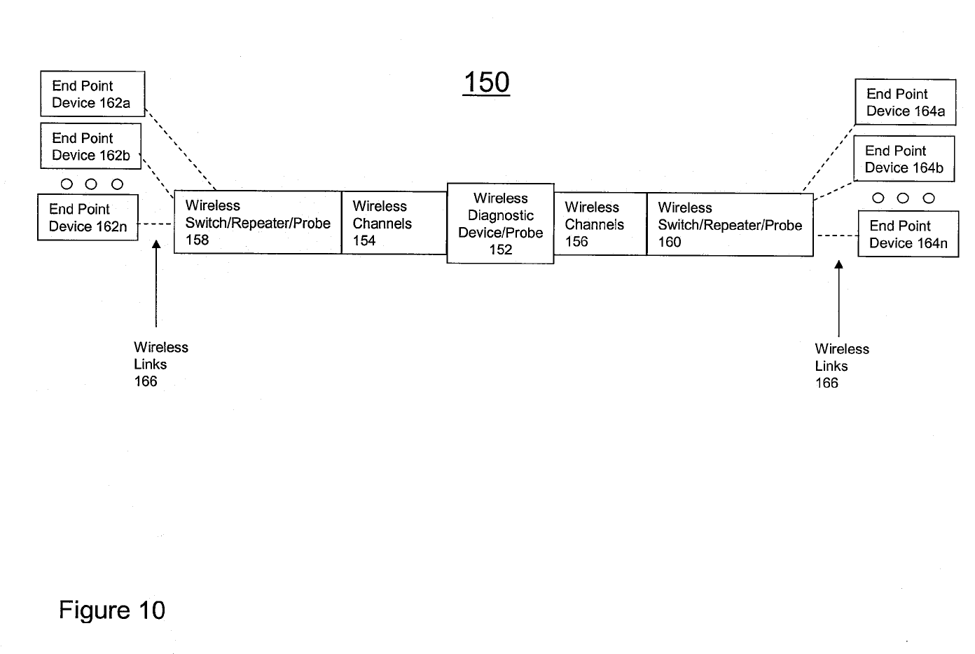

FIG. 10 is a block diagram of an exemplary diagnostic system 150 utilizing switching technology. A WDD/probe 152 can be configured to monitor various data transmitted over the wireless channels 154, 156 from switch/repeater/probes 158, 160. Switch/repeater/probes 158, 160 detect data from one or more end point devices 162a-n and 164a-n. For example FIG. 10 illustrates end point devices 162 communicating with a wireless switch/repeater/probe 158 and end point devices 164 communicating with a wireless switch/repeater/probe 160. The wireless switches/repeater/probe 158 and 160 may be interconnected using one or more wireless links 166 and/or any other suitable line or connection, such as optical or electrical. In this example, a WDD/probe 152 is configured to communicate with the wireless switches/repeaters/probes 158, 160 via wireless channels. As used herein, “wireless channels” includes, but is not limited to, a wireless communication link comprising a plurality of wireless connections adapted to provide communication paths.

The switch/repeater/probe 158, 160 refers to the fact that various types of devices can be used to receive multiple channels. The switch uses switching technology in order to be able to monitor data on the multiple end point devices 162, 164. The repeater aggregates low-power signals from multiple end point devices 162, 164 and transmits a higher-power signals to WDD/probe 152, which may also incorporate switching technology. Additionally, the wireless probe can receive data from end point devices 162, 164 before retransmitting the data to another WDD/probe 72 or analyzer/collector 55. In one embodiment, the wireless switch/repeater/probes 158, 160 can be considered to be discrete and separate components that have the hardware and software to perform as a switch, repeater, or a probe. Alternatively, the switch/repeater/probe 158, 160 can have the hardware and software to perform a combination of the switch, repeater, and/or probe functions. Thus, FIG. 10 illustrates that, in one embodiment, a switch/probe 158, 160 may be configured for housing the components for both switching and functioning as a WDD/probe. This may reduce the number of components that need to be implemented in a network. In any event, the wireless switches/repeaters/probes 158, 160 and/or WDD/probe 152 can switch between various channels so that a single WDD/probe 152 can pass, monitor, and analyze data that is transmitted over the wireless channels 154, 156 from end point devices 162, 164.

IV. Wireless Channels

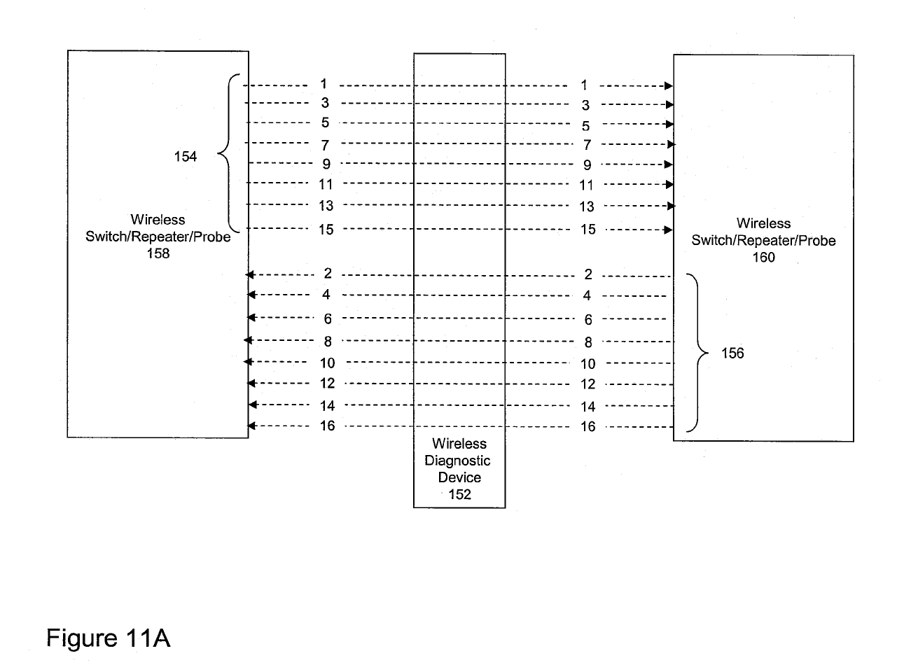

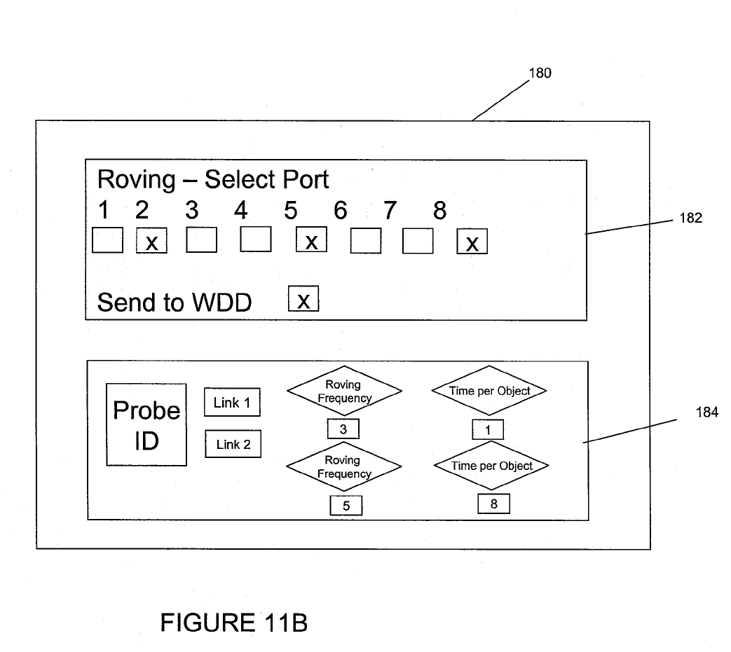

FIG. 11A is a block diagram illustrating wireless channels 154 and 156 included in the networking system 150 shown in FIG. 10. Nodes in a network may communicate using wireless channels 154, 156, switches, wireless switches, wireless repeaters, wireless probes, or any suitable combination thereof. Advantageously, because a wireless switch/repeater/probe 158, 160 may use any of the communication paths available as wireless channels, the switch/repeater/probe need not wait for a particular communication path to send a particular data. Accordingly, by leveraging the communication paths provided by wireless channels, many communication bottlenecks may be avoided.

Generally, wireless channels provide a plurality of communication paths in one direction and/or a plurality of communication paths in an opposite direction. Of course, wireless channels may provide the same number or a different number of communication paths in opposite directions. FIG. 1A shows a first set 154 of channels (as shown by dashed lines 1, 3, 5, 7, 9, 11, 13, and 15) to which wireless switch/repeater/probe 158 has access to transmit data. As shown in FIG. 1A, when switch/repeater/probe 158 transmits on any of these channels, anything within the range of switch/repeater/probe 158 can detect the channels and obtain information from the channels. So, assuming they are in range, in addition to switch/repeater/probe 160 being able to access the data on channels 154, WDD/probe 152 is also able to access the data, as shown by the lines 1, 3, 5, 7, 9, 11, 13 and 15 crossing over WDD/probe 152.

Similarly, wireless switch/repeater probe 160 has access to a second set 156 of channels (as shown by dashed lines 2, 4, 6, 8, 10, 12, 14 and 16) on which it can transmit information. Likewise, devices within range, such as WDD/probe 152 and/or switch/repeater/probe 158 can detect information on the channels 156. Because the wireless channels may provide a plurality of communication paths in opposing directions, first data may be sent on any of the channels in one direction and a second data or portion thereof sent in response to the first data may be sent on any of the channels in the opposing direction.

In one embodiment, some or all of the channels 154, 156 may each provide at least about 2 gigabits per second bandwidth or higher. Of course, wireless switch/repeater/probe 158, 160 may provide less than 16 channels, more than 16 channels, or any other suitable number of channels. Also, the channels 154, 156 may have any other suitable bandwidth, including lesser or greater bandwidths.

Advantageously, because the network components of the present invention, or any other wireless communication device, may use any of the channels in a wireless channel scheme, the wireless devices need not wait for a particular channel to send a particular data, but can be configured to skip through various channels in order to access an available channel. For example, the wireless switch/repeater/probe 158 or WDD/probe 152 can use switching software that enables it to quickly establish links to any connection on the wireless network, such as scheduling sampling throughout the network. This ability for a single wireless switch/repeater/probe that can cover an entire network by quickly switching from connection to connection can not only increase the ability for the wireless network to function properly, but can also remove the complications of having multiple switches/repeaters/probes. This is because a single wireless switch/repeater/probe can now patch into or TAP into any wirelessly enabled port within the communication network. However, larger networks, or those that cover an extended area, may need to implement multiple switches/repeaters/probes.

V. Exemplary User Interface

As disclosed in FIG. 11B, one embodiment of the invention relates to a user interface 180 for enabling a user to select the switching and/or roaming configuration of a wireless diagnostic network. The user interface can include controls 182 for allowing a user to specify roving or roaming parameters. Roving is a method of monitoring traffic data that forwards a copy of each incoming and outgoing packet from one port of a network switch to another port where the packet can be studied. A network administrator uses roving as a diagnostic tool or debugging feature, especially when fending off an attack. It enables the administrator to keep close track of switch performance and alter it if necessary. The user interface 180 allows roving to be controlled locally or remotely. Controls 182 allow a user to assign a port from which to copy all data and to send that data wirelessly to an assigned WDD/probe. Data bound for or heading away from the first port will be forwarded onto WDD/probe as well. In this manner, the WDD/probe can capture and evaluate data without affecting the end point device having the original port. User interface 180 may also include controls 184 for allowing a user to select roving frequency.

User interface 180 may also include controls that allow a user to configure the wireless network, set switching frequency, set channels, set mode of sending/receiving wireless signals for each device such as workgroup or domain IP communication protocols, and the like.

VI. Exemplary Wireless Diagnostic Device

As discussed above, WDD/probe 52, 72 and/or 152 can be configured to be a network monitoring tool, such as, but not limited to, a wireless probe, wireless network TAP, bit error rate tester, a protocol analyzer, a generator, a jammer, a statistical monitor, or other diagnostic tool. FIG. 12 is a general schematic diagram illustrating an embodiment of a WDD/probe 200 in accordance with the present invention. WDD/probe 200 includes a housing 202 that is configured to enclose the electronics 204 and hardware 206 required to generate, receive, transmit, monitor, analyze, and/or store wireless communications. More particularly, the WDD/probe 200 can include wireless communication components 208 that are configured to enable wireless communications. As such, the electronics 204, hardware 206, and/or wireless communication components 208 can be in communication with an antenna 210 so that adequate transmission and reception of wirelessly transmitted data can be obtained. Additionally, the WDD/probe 200 includes a processor device 212 and a memory device 214.

The WDD/probe 200 can include an adapter port 216. The adapter port 216 can be configured to be a plug-and-play adapter port that can receive pluggable modules. By providing an adapter port 216 that can receive pluggable modules, the WDD/probe 200 can be updated to be compatible with new functionality, equipment and/or protocols as desired.

In one embodiment, the WDD/probe 200 can include a buffer 218. Such a buffer 218 can be a small wrapping buffer that continuously records data stream in real time, such as the diagnostic data, that is being monitored and/or analyzed. Systems and methods for using buffer 218 will be disclosed below in further detail.

Additionally, the WDD/probe 200 can include software 220 for enhancing the functionalities of the WDD/probe 200 as well as the entire wireless network. Such software can be conversion software 220a, which includes computer-executable instructions for converting RF to input. Additionally, the software can be switching software 220b, which allows the WDD/probe 200 to quickly establish links to any connection on the wireless network. For example, the switching software 220b can enable complex scheduling for data samples to be acquired by the WDD/probe 200 from various wirelessly enabled devices within the wireless network.

Additionally, the WDD/probe 200 can include service contract software 220c. Service contract software 220c can enable a wireless network manager to set up the WDD/probe 200 in a manner that allows for remote access, such as by a remote protocol analyzer/monitor, to analyze the functionalities of the wireless network. Thus, the service contract software 220c can provide a means for the remote analysis of the wireless network based on the data acquired by the WDD/probe 200, especially when WDD/probe 200 is a wireless probe.

In one embodiment, the service contract software 220c can be configured to contact the service provider when an error or problem in the network occurs. This can include providing the service provider with the identification and location of the diagnostic data. More particularly, the software can notify the service provider of the location of the diagnostic data within an aggregation server, which includes the data obtained from the buffer 218 and the data stream sent to the point share server after the error or problem. As such, the service provider can then remotely access the diagnostic data that was originally obtained from the buffer 218 so that the network functionality can be analyzed before, during, and after the error or problem occurred.

Moreover, the software can be intrusion detection software 220d, which monitors for unauthorized attempts to access any aspect of the wireless network, and functions to terminate such attempts by hackers. The intrusion detection software can watch for unusual patterns or unidentified IP addresses. When an unauthorized attempt is made to access the wireless network, the intrusion software can block the attempt, disable the port being breached, or implement any other known method for inhibiting or terminating unauthorized access.

In one embodiment, the WDD/probe 200 can include data storage 222. The data storage 222 can be any type of data storage unit, such as any optical, magnetic or any other storage material in the form of a hard drive, disk drive, or any other storage structure, that enables the WDD/probe 200 to be capable of storing any data that is communicated thereto. As such, the data storage 222 can record and save the traffic or diagnostic data being communicated on the wireless network as well as record and save any command controls provided by an analyzer or user. More particularly, when a user receives the diagnostic data from the WDD/probe 200, any commands or instructions for handling the diagnostic data or correcting the problem identified by the diagnostic data can be recorded and saved within the data storage 222. Additionally, the data storage 222 can enable a user to upload additional firmware, software, and/or patches or otherwise upgrade the diagnostic device. Note that the end point could also be upgraded by transmitting upgrade software wirelessly to an end point device. The ability of an end user to interact with the WDD/probe 200 and control the functions thereof provides for enhanced usability and operation of a wireless diagnostic system.

Moreover, the WDD/probe 200 can either include end user interfaces (not shown) such as a monitor, keyboard, mouse, and the like or adapters (not shown) for such interfaces.

As discussed above, WDD/probe 200 can be used in wireless diagnostic systems by using wireless communication. In one embodiment, the WDD/probe 200 may comprise one or more wireless hardware modules, one or more wireless software modules, or both. In one embodiment, WDD/probe 200 can communicate between the wireless switches/repeaters/probes 158 and 160 with wireless technology such that the traffic data available to the wireless switches/repeaters/probes is available to the diagnostic module or is routed through the WDD/probe 200. The wireless switches 158 and 160 can be coupled to physical transmission media that are passing data through the network. The wireless switches 158 and 160 can then wirelessly communicate information to the wireless diagnostic device. As such, the wireless switches 158 and 160 can be common switches for optical or electrical communications in any network environment, and include a wireless communication software or hardware module to enable wireless communications for diagnostic or monitoring purposes.

The WDD/probe 200 may perform a variety of network diagnostic functions. In performing some of these diagnostic functions, the WDD/probe 200 may be configured to be passive to traffic data comprising data. Accordingly, the diagnostic module may passively receive at least some of the traffic data, and may passively transmit some or all of the received traffic. However, it may be preferable for the WDD/probe 200 to simply receive information about the network via a wireless link. In performing other diagnostic functions, the WDD/probe 200 may be configured to alter some or all of the traffic data and/or generate traffic data.

VII. Exemplary Diagnostic Devices

As mentioned above, the WDD/probe 52, 72, 152 or 200 may perform a variety of diagnostic functions. Where a probe includes the ability to perform diagnostic functions, it can be referred to as a wireless diagnostic device, which term will be used to describe the exemplary diagnostic functions that can be performed by the WDD/probe. However, it should be clear that a wireless diagnostic device can also include the function of a probe. Exemplary diagnostic functions include, but are not limited to, as any combination of: a bit error rate tester, a protocol analyzer, a generator, a jammer, a statistical monitor, as well as any other appropriate diagnostic device.

1. Bit Error Rate Tester

In some embodiments, the wireless diagnostic device may function as a wireless bit error rate tester. The wireless bit error rate tester may generate and/or transmit, by a wireless link, data in the form of an initial version of a bit sequence to another device (such as another device in a network) so that the bit sequence can be propagated through a communication path. If desired, the initial version of the bit sequence may be user selected. The bit error rate tester may also receive, by a wireless link, data in the form of a received version of the bit sequence from another device (such as another device in a network) that has received the bit sequence via a communication path.

The wireless bit error rate tester compares the received version of the bit sequence (or at least a portion of the received version) with the initial version of the bit sequence (or at least a portion of the initial version). In performing this comparison, the bit error rate test may determine whether the received version of the bit sequence (or at least a portion of the received version) matches and/or does not match the initial version of the bit sequence (or at least a portion of the initial version). The wireless bit error tester may thus determine any differences between the compared bit sequences and may generate statistics at least partially derived from those differences. Examples of such statistics may include, but are not limited to, the total number of errors (such as, bits that did not match or lost bits), a bit error rate, and the like.

A particular protocol specification may require a bit error rate to be less than a specific value. Thus, a manufacturer of physical transmission components and connections (such as, optical cables), communication chips, wireless communication modules, and the like, may use the bit error rate tester to determine whether their components comply with a protocol-specified bit error rate. Also, when communication components are deployed, the wireless bit error tester may be used to identify defects in components included in a physical communication path or wireless communication path.

2. Protocol Analyzer

In some embodiments, the wireless diagnostic device may function as a wireless protocol analyzer, which may be used to capture or receive data for further analysis. The analysis of the captured or received data may, for example, be used to diagnose data transmission faults, data transmission errors, performance errors (known generally as problem conditions), and/or other conditions.

As disclosed below, the wireless protocol analyzer may be configured to receive data in the form of a bit sequence via one or more communication paths or channels. As such, the bit sequence can be received via a wire link, or from a wireless link. Typically, the bit sequence comprises data in the form of, but not limited to, packets, frames, or other protocol-adapted data. In one embodiment, the wireless protocol analyzer passively receives the data via wireless communication.

The wireless protocol analyzer may be configured to compare the received bit sequence (or at least a portion thereof) with one or more bit sequences or patterns. Before performing this comparison, the protocol analyzer may optionally apply one or more bit masks to the received bit sequence. In performing this comparison, the wireless protocol analyzer may determine whether all or a portion of the received bit sequence (or the bit-masked version of the received bit sequence) matches and/or does not match the one or more bit patterns. In one embodiment, the bit patterns and/or the bit masks may be configured such that the bit patterns will (or will not) match with a received bit sequence that comprises data having particular characteristics—such as, for example, having an unusual network address, having a code violation or character error, having an unusual timestamp, having an incorrect CRC value, indicating a link re-initialization, and/or having a variety of other characteristics.

The wireless protocol analyzer may detect data having any specified characteristics, which specified characteristics may be user-selected via user input. A specified characteristic could be the presence of an attribute or the lack of an attribute. Also, the protocol analyzer may detect data having particular characteristics using any other suitable method.

In response to detecting data having a set of one or more characteristics, the wireless protocol analyzer may execute a capture of new data in the form of a bit sequence or portion of a bit sequence. For example, in one embodiment, when the wireless protocol analyzer receives new data, the wireless protocol analyzer may buffer, cache, or otherwise store a series of new data in a circular buffer. Once the circular buffer is filled, the wireless protocol analyzer may overwrite (or otherwise replace) the oldest data in the buffer with the newly received data or messages.

Thus, when the wireless protocol analyzer receives new data, the network may detect whether the data has a set of one or more specified characteristics. In response to detecting that the received data has the one or more specified characteristics, the wireless protocol analyzer may execute a capture (1) by ceasing to overwrite the buffer (thus capturing some data prior to new data), (2) by overwriting at least a portion or percentage of the buffer with newly received data (thus capturing at least some old data and some additional data after the received data), or (3) by overwriting the entire buffer (thus capturing all new data after the received data). In one embodiment, a user may specify via user input a percentage of the buffer to store old data before the new data, a percentage of the buffer to store additional data after the new data, or both. In one embodiment, a protocol analyzer may convert a captured bit stream into another format. In one embodiment, the data capture device outfitted with a wireless transceiver and can capture the data being passed through a communication path, and then transmit the data to the wireless protocol analyzer via a wireless link.

In response to detecting data having a set of one or more characteristics, a wireless protocol analyzer may generate a trigger adapted to initiate a capture of a bit sequence. Also, in response to receiving a trigger adapted to initiate a capture of a bit sequence, a protocol analyzer may execute a capture of a bit sequence. For example, the protocol analyzer may be configured to send and/or receive a wireless trigger signal among a plurality of wireless protocol analyzers. In response to detecting that a received data has the one or more specified characteristics, a wireless protocol analyzer may execute a capture and/or send a wireless trigger signal to one or more protocol analyzers that are configured to execute a capture in response to receiving such a trigger signal.

A capture may be triggered in response to detecting any particular circumstance—whether matching a bit sequence and bit pattern, receiving an external trigger signal, detecting a state (such as, when a protocol analyzer's buffer is filled), detecting an event, detecting a multi-network-message event, detecting the absence of an event, detecting user input, or any other suitable circumstance.

The wireless protocol analyzer may optionally be configured to capture a portion of data. For example, the wireless protocol analyzer may be configured to store at least a portion of a header portion of data, but discard at least a portion of data payload. Thus, the wireless protocol analyzer may be configured to capture and to discard any suitable portions of data.

A particular protocol specification may require data to have particular characteristics. Thus, a manufacturer of network devices and the like may use the wireless protocol analyzer to determine whether their devices comply with a protocol. Also, when devices are deployed, the wireless protocol analyzer may be used to identify defects in a deployed device or in other portions of a deployed system.

During operation, the wireless protocol analyzer can sort through a plurality of events, which can include up to or greater than one million events. As such, the protocol analyzer can then identify performance, upper layer protocol, logical and physical layer issues. When a questionable event has occurred, the protocol analyzer can flag the protocol violation, interoperability problem, performance issue, or errant behavior for further analysis or service.

3. Generator

In some embodiments, the wireless diagnostic device may function as a wireless generator. The wireless generator may generate and/or transmit data in the form of a bit sequence via one or more communication paths or channels. Typically, the bit sequence is in the form of, such as, packets, frames, or other protocol-adapted forms. The data may comprise simulated traffic data between devices in a system. Advantageously, an administrator may evaluate how the devices respond to the simulated traffic data. Thus, the administrator may be able to identify performance deviations and take appropriate measures to help avoid future performance deviations.

4. Jammer

In some embodiments, the wireless diagnostic device may function as a wireless jammer. The wireless jammer may receive, generate, and/or transmit data in the form of bit sequences via one or more wireless communication paths or channels. Typically, the bit sequences comprise data in the form of packets, frames, or other protocol-adapted forms and can be traffic data between devices in a system. The wireless jammer may be configured as a wireless component of a system such that the wireless jammer may receive and transmit data via wireless communications.

Prior to transmitting the received data, the wireless jammer may selectively alter at least a portion of the traffic data, which alterations may introduce protocol errors or other types of errors. Thus, by altering at least a portion of the traffic data, the wireless jammer may generate traffic data that can be used to test a system. For example, an administrator may then evaluate how the devices in a system respond to these errors. For example, a system designer can perform any one of a number of different diagnostic tests to make determinations such as whether a system responded appropriately to incomplete, misplaced, or missing tasks or sequences, how misdirected or confusing frames are treated, and/or how misplaced ordered sets are treated.

In one embodiment, to determine which data to alter, the wireless jammer may be configured to compare data such as a received bit sequence or portion thereof with one or more bit sequences or patterns. Before performing this comparison, the wireless jammer may optionally apply one or more bit masks to the received bit sequence. In performing this comparison, the wireless jammer may determine whether all or a portion of the received bit sequence (or the bit-masked version of the received bit sequence) matches and/or does not match the one or more bit patterns. In one embodiment, the bit patterns and/or the bit masks may be configured such that the bit patterns will (or will not) match with a received bit sequence (or portion thereof) when the received bit sequence comprises data from a particular device, data from communication between one or more devices, data of a particular format or type, and the like. Accordingly, the wireless jammer may be configured to detect data having any specified characteristics. Upon detection of the data having the specified characteristics, the wireless jammer may alter the data and/or data subsequent to that data.

5. Statistical Monitor

In some embodiments, the wireless diagnostic device may function as a wireless statistical monitor, which may be used to derive statistics from data having particular characteristics, one or more data communications having particular characteristics, and the like. As disclosed below, the wireless statistical monitor may be configured to receive data in the form of a bit sequence via one or more wireless communication paths or channels. Typically, the wireless statistical monitor passively receives the data via one or more wireless network connections.

To determine the data and/or communications from which statistics should be derived, the wireless statistical monitor may be configured to compare a received a bit sequence or portion thereof with one or more bit sequences or patterns. Before performing this comparison, the wireless statistical monitor may optionally apply one or more bit masks to the received bit sequence. In performing this comparison, the wireless statistical monitor may determine whether all or a portion of the received bit sequence (or the bit-masked version of the received bit sequence) matches and/or does not match the one or more bit patterns. In one embodiment, the bit patterns and/or the bit masks may be configured such that the bit patterns will (or will not) match with a received bit sequence (or portion thereof) when the received bit sequence comprises data from a particular device, data between one or more devices, data of a particular format or type, data having a particular error, and the like. Accordingly, the wireless statistical monitor may be configured to detect data having any specified characteristics—including but not limited to whether the data is associated with a particular communication among devices.

Upon detecting data having specified characteristics, the wireless statistical monitor may create and update table entries to maintain statistics for individual data and/or for communications between nodes. For example, a wireless statistical monitor may count the number of physical errors (such as, bit transmission errors, CRC error, and the like), protocol errors (such as, timeouts, missing data, retries, out of orders), other error conditions, protocol events (such as, an abort, a buffer-is-full message), and the like. Also, as an example, the wireless statistical monitor may create communication-specific statistics, such as, the number of packets exchanged in a communication, the response times associated with the packets exchanged in a communication, transaction latency, block transfer size, transfer completion status, aggregate throughput, and the like. A specified characteristic could be the presence of an attribute or the lack of an attribute.

a) Exemplary Ethernet LAN Statistics

A wireless statistical monitor, such as Surveyor™ (Finisar; Sunnyvale, Calif.) outfitted with wireless components, may generate data in the form of a variety of statistics, which, in some embodiments, may be used to trigger a bit sequence capture. In some embodiments, statistics may be generated for Ethernet LANs or other wireless networks.

For example, the LAN statistics may include a variety of host-specific statistics such as network-layer statistics for a particular virtual LAN, and application-layer statistics for a particular virtual LAN identifier and application protocol, wherein the statistics can include the number of frames to and from the host, the number of errors to and from the host, the percent of the theoretical bandwidth used by traffic to and from the host, and/or other like statistics. Additionally, the LAN statistics may include a variety of multi-host statistics for a pair of hosts such as network-layer statistics for a particular virtual LAN, and application-layer statistics for a particular virtual LAN identifier and application protocol, wherein the statistics can include the number of frames between the pair of hosts, the percent of the theoretical bandwidth used by the conversation between the pair of hosts, the number of errors between the pair of hosts, and/or other like statistics.

In one embodiment, the LAN statistics may include protocol distribution statistics such as the number of packets for a protocol, the percent of all packets which were this protocol, the percent of the theoretical bandwidth used by this protocol, and/or other like statistics. Additionally, the LAN statistics may include a variety of utilization-related statistics, error-related statistics, frame-size statistics, and application-layer statistics for a particular application protocol, wherein these statistics are well known in the art.

Additionally, any other LAN statistics known or developed can be employed in diagnostic device and system. Of course, any of the LAN statistics may be used for any suitable type of wireless network other than a LAN using any suitable protocol other than Ethernet.

b) Exemplary SAN Statistics

Also, a wireless statistical monitor, such as Xgig™ or NetWisdom™ (Finisar; Sunnyvale, Calif.) outfitted with wireless components, may generate data in the form of a variety of statistics, which, in some embodiments, may be used to trigger a bit sequence capture. In some embodiments, statistics may be generated for SANs such as wireless SANs.

In one embodiment, the SAN statistics may include a variety of link metrics such as the total number of frames of any type per second, the total megabytes of frame payload data per second, the total number of management frames per second, total application data frames per second, the percentage of total theoretical bus capacity consumed by the payload bytes, and/or other like statistics. Additionally, the SAN statistics may include a variety of link event statistics such as the number of times a link has transitioned into a loss of sync state in an interval, the number of times a link has transitioned to a loss of signal state in an interval, the number of fabric frames in an interval, the number of link control frames in an interval, framing errors that may occur on any link with media or transmission problems, and/or other like statistics.

In one embodiment, the SAN statistics may include a variety link group statistics such as the number of login type frames in an interval, the number of logout type frames in an interval, the number of notification type frames in an interval, the number of reject type frames in an interval, the number of busy type frames in an interval, the number of accept type in an interval, and/or other like statistics. Additionally, the SAN statistics may include a variety of link pending exchange statistics such as the number of exchanges that have been opened, but not closed in an interval, the maximum number of exchanges open at one time during an interval, and/or other like statistics.

Additionally, any other SAN statistics known or developed can be employed in diagnostic device and system. Of course, any of the SAN statistics may be used for any suitable type of network other than a SAN using any suitable protocol.

VIII. Exemplary Shared Resources System

FIG. 13 illustrates that, in one embodiment, buffered data 218 shown in FIG. 12 can be used in a shared resource system 300, which can optionally be used in conjunction with the service contract software 220c disclosed in connection with FIG. 12. As such, the shared resource system 300 includes a plurality of end point devices represented by end point device 302a-302n. End point devices 302a-302n are in wireless communication with a device 303 housing a buffer 304. Buffer 304 has much the same functionality as disclosed above with reference to buffer 218 disclosed in FIG. 12. That is, buffer 304 can include looped memory that constantly records the diagnostic data (e.g., smart data) being transmitted from the end point devices 302a-302n (e.g., RAID), wherein the new diagnostic data is continuously overwriting old diagnostic data. In one embodiment, device 303 can be a WDD/probe 200 outfitted with a buffer 218 (see FIG. 12). However, device 303 can be any wireless device to which end point devices 302a-302n can wirelessly transmit information.

Further, the wireless device 303 containing buffer 304 can communicate with an aggregation server 306 so that the server 306 can receive the diagnostic data stored on buffer 304. Communication between the device 303 and aggregation server 306 can be wireless or via physical transmissions. A resource allocation manager 308 is physically or wirelessly connected to aggregation server 306. The resource allocation manager 308 is, in turn, in communication with various diagnostic services 310a-310d. Diagnostic services 310a-310d are comprised of hardware and/or software for performing certain diagnostic functions. For example diagnostic service 310a is a protocol analyzer, diagnostic service 310b is a bit error rate tester, diagnostic service 310c is a jammer, and diagnostic service 310d represents other diagnostic devices that may be provided such as those listed in this detailed description and others known to those of skill in the art. More particularly, the diagnostic device 310d could include any of the individual diagnostic devices such as a statistical monitor, protocol analyzer, bit error rate tester, generator, jammer, and like, as well as combinations thereof. Further, any of diagnostic services 310a-310d may be formed as part of resource allocation manager 308 or may be remotely accessible by resource allocation manager 308 via physical or wireless connection.

Each component of this system may be within a client's network, or some components may communicate using, for example, the Internet. Secure connection is preferably provided between resource allocation manager 308 and aggregation server 306.

In operation, the shared resource system 300 is configured such that the device 303 logs the diagnostic data in the buffer 304 in a continuous loop manner, as disclosed above. As such, when an error or problem occurs in end point device 312, the diagnostic data that was stored in the buffer prior to the error or problem and during the error or problem is transmitted to the aggregation server 306. Further, the device 303 is configured with hardware and/or software that causes any diagnostic data in the buffer 304 that is relevant to an error or problem to be transmitted to the aggregation server 306. Additionally, the device 303 is configured to stream any diagnostic data relevant to the error or problem along with the diagnostic data from the buffer. Additionally, the diagnostic data received by device 303 after the error or problem is then streamed to the aggregation server 306. This provides full-scope diagnostic data about the functionality of the end point device 312 in all stages of an error or problem, including the diagnostic data before the device 303 identified the problem. Also, the diagnostic data can include all traffic being monitored or filtered traffic.

After the device 303 begins to transmit the diagnostic data to the aggregation server 306, the resource allocation manager 308 is notified of the error or problem. As such, the resource allocation manager 308 accesses diagnostic services 310a-310d to analyze the diagnostic data as well as any statistics associated therewith. The resource allocation manager 308 is also capable of accessing the diagnostic data and associated statistics from the aggregation server 306, wherein the diagnostic data can be analyzed while being stored at the aggregation server 306, or transmitted to the appropriate diagnostic service 310a-310d for analysis. Thus, the resource allocation manager 308 can choreograph the diagnostic and analytical protocols required to determine the problem, and optionally how to correct the problem.

Thus, resource allocation manager 308 is notified of an error in end point devices 302a-302n by buffer 304 locate in, for example, device 303, sending such notice to aggregation server 306, which, in turn, notifies the resource allocation manager 308. Thus, in this indirect manner, the resource allocation manager 308 can be notified by the buffer 304 when an error or problem arises, and then can read the diagnostic data relevant to the error or problem from the aggregation server 306.

In one embodiment, the network operator or host of the network, in which the end point devices 302a-302n reside, can have a service contract with a remote analytical firm. As such, the remote analytical firm can have powerful diagnostic analyzers and tools 310a-310d that are needed in order to determine the source of the problem. When a device 303 detects a problem, it transmits traffic and/or diagnostic data to the aggregation server 306, and notifies the remote analytical firm about the problem, and provides the location of diagnostic data. This can be done with the aforementioned service contract software. In any event, the remote analytical firm can then access and retrieve that diagnostic data, and analyze the diagnostic data with more powerful diagnostic analyzers and tools 310a-310d. After a complete analysis, the remote analytical firm can then report any helpful information that could be extracted from the diagnostic data to the network operator or host.

In another similar embodiment, the device 303 notifies the resource allocation manager 308 about an error or issue, and the foregoing analytical and diagnostic protocols are initiated to determine what is needed to analyze the diagnostic data. The service contract software can then verify whether or not any technicians at the remote analytical firm are available to handle the error or problem. If it is determined that no technicians are available, the software or resource allocation manager 308 can log the problem. Alternatively, if no technicians are available, the software or resource allocation manager 308 can assess whether immediate attention needs to be directed to the problem. When the problem is determined to be urgent, the software can instruct the remote analytical firm to pull a technician in order to handle the problem. On the other hand, when a technician is available, the software or resource allocation manager 308 can inform the technician of the problem and implement a diagnostic and analytical protocol.

IX. Exemplary Operating and Computing Environments

The methods and systems disclosed above can be implemented using software, hardware, or both hardware and software. For example, the software may advantageously be configured to reside on an addressable storage medium and be configured to execute on one or more processors. Thus, software, hardware, or both may include, by way of example, any suitable module, such as software components, object-oriented software components, class components and task components, processes, functions, attributes, procedures, subroutines, segments of program code, storage devices, firmware, microcode, circuitry, data, databases, data structures, tables, arrays, variables, field programmable gate arrays (“FPGA”), a field programmable logic arrays (“FPLAs”), a programmable logic array (“PLAs”), any programmable logic device, application-specific integrated circuits (“ASICs”), controllers, computers, wireless components, wireless software, and firmware to implement those methods and systems disclosed above. The functionality provided for in the software, hardware, or both may be combined into fewer components or further separated into additional components. Additionally, the components may advantageously be implemented to execute on one or more computing devices. As used herein, “computing device” or “computing system” is a broad term and is used in its ordinary meaning and includes, but is not limited to, devices such as, personal computers, desktop computers, laptop computers, palmtop computers, a general purpose computer, a special purpose computer, mobile telephones, personal digital assistants (PDAs), Internet terminals, multi-processor systems, hand-held computing devices, portable computing devices, microprocessor-based consumer electronics, programmable consumer electronics, network PCs, minicomputers, mainframe computers, computing devices that may generate data, any wirelessly enabled computing device, and computing devices that may have the need for storing data, and the like.

Also, one or more software modules, one or more hardware modules, or both may be used in performing some or all of any of the methods disclosed herein. Further, one or more software modules, one or more hardware modules, or both may be used in implementing any other functionality or aspects disclosed herein.

Embodiments within the scope of the present invention also include computer-readable media for carrying or having computer-executable instructions or data structures stored thereon. Such computer-readable media can be any available media that can be accessed by a computing device. By way of example, and not limitation, such computer-readable media can comprise any storage device or any other medium which can be used to carry or store desired program code in the form of computer-executable instructions or data structures and which can be accessed by a computing device.

When information is transferred or provided over a wireless network or another communications connection (either physically connected, wireless, or a combination of physically connected or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a computing device to perform a certain function or group of functions. Data structures include, for example, data frames, data packets, or other defined or formatted sets of data having fields that contain information that facilitates the performance of useful methods and operations. Computer-executable instructions and data structures can be stored or transmitted on computer-readable media, including the examples presented above.

The present invention may be embodied in other specific forms without departing from its spirit or essential characteristics. The disclosed embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A network TAP comprising:
an input port configured for communication with a data line;
an output port configured for communication with a data line and the output port being at least indirectly connected with the input port;
a power assembly; and
a wireless transmitter connected with the power assembly, the wireless transmitter configured to receive data by way of the input port, and the wireless transmitter configured to transmit data over a wireless channel.

2. The network TAP as recited in claim 1, wherein the network TAP is programmable.

3. The network TAP as recited in claim 1, wherein the power assembly comprises a connection to an external power supply.

4. The network TAP as recited in claim 1, wherein the input port is passively connected to the output port.

5. The network TAP as recited in claim 1, wherein the input port is actively connected to the output port.

6. The network TAP as recited in claim 1, wherein the wireless transceiver is compatible with the IEEE 802.11 standard.

7. The network TAP as recited in claim 1, further comprising a monitor port configured to be coupled to a data line and configured to output data received at the input port.

8. The network TAP as recited in claim 1, further comprising:
a processor;
a memory in communication with the processor;
a buffer in communication with the processor; and
a wireless receiver in communication with the processor, the wireless receiver configured to receive data over a wireless channel.

9. The network TAP as recited in claim 8, wherein the wireless receiver is configured to receive control signals over the wireless channel.

10. The network TAP as recited in claim 9, wherein the control signals are configured to cause a portion of the data received at the input port to be stored in the buffer for eventual transmission by the wireless transmitter to an aggregation server.

11. The network TAP as recited in claim 10, wherein the portion of the data corresponds to an event in the data received at the input port.

12. An optical network TAP comprising:
an optical input port configured for communication with an optical data line;
an optical output port configured for communication with an optical data line and the optical output port being at least indirectly connected with the optical input port;
a power assembly; and
a wireless transmitter connected with the power assembly, the wireless transmitter configured to receive data by way of the optical input port, and the wireless transmitter configured to transmit data over a wireless channel.

13. The optical network TAP as recited in claim 12, further comprising an optical coupler, the optical coupler configured to receive the data by way of the optical input port, the optical coupler configured to transmit the received data to the optical output port and the wireless transmitter.

14. The optical network TAP as recited in claim 13, further comprising an optical monitor port; the optical monitor port configured to receive data transmitted from the optical coupler.

15. The optical network TAP as recited in claim 13, wherein the optical coupler is passive.

16. The optical network TAP as recited in claim 12, further comprising:
a processor;
a memory in communication with the processor; and
a wireless receiver in communication with the processor, the wireless receiver configured to receive data over a wireless channel.

17. The optical network TAP as recited in claim 16, wherein the wireless receiver is further configured to receive control signals over a wireless channel.

18. An electrical network TAP comprising:
an electrical input port configured for communication with an electrical data line;
an electrical output port configured for communication with an electrical data line and the electrical output port being at least indirectly connected with the electrical input port;
a power assembly; and
a wireless transmitter connected with the power assembly, the wireless transmitter configured to receive data by way of the electrical input port, and the wireless transmitter configured to transmit the received data over a wireless channel.

19. The electrical network TAP as recited in claim 18, further comprising an operational amplifier; the operational amplifier configured to received the data by way of the electrical input port; the operational amplifier configured to transmit the received data to the electrical output port and the wireless transmitter.

20. The electrical network TAP as recited in claim 19, further comprising an electrical monitor port disposed in the housing; the electrical monitor port configured to receive data transmitted from the operational amplifier.

21. The electrical network TAP as recited in claim 18, further comprising:
a processor;
a memory in communication with the processor; and
a wireless receiver in communication with the processor, the wireless receiver configured to receive data over a wireless channel.

22. The electrical network TAP as recited in claim 21, wherein the wireless receiver is further configured to receive control signals over a wireless channel.
